(19) United States
(12) Patent Application Publication
(10) Pub. No.: US 2002/0169835 A1
(43) Pub. Date: Nov. 14, 2002

(54) E-mail communications system, method and program

(75) Inventors: Glen Hale Paul JR., Tallahassee, FL (US); Jeffrey S. Minder, Tallahassee, FL (US)

Correspondence Address: ROBERT C. KAIN, JR., 750 SOUTHEAST THIRD AVENUE, SUITE 100, FT LAUDERDALE, FL, 333161153

(73) Assignee: IMARCSGroup.com,LLC

(21) Appl. No.: 09/765,011

(22) Filed: Jan. 18, 2001

Related U.S. Application Data
(60) Provisional application No. 60/260,772, filed on Jan. 10, 2001.
(60) Provisional application No. 60/259,347, filed on Dec. 30, 2000.

(51) Int. Cl. G06F 15/16

(52) U.S. Cl. 709/206; 709/207

(57) ABSTRACT

The Internet-based method of communicating interacts with a plurality of members each having a computer-based communications system with an e-mail facility. The method of communicating, in one embodiment, includes a web-based user interface for data input of member data. The member data includes communications data (e-mail address) for each member, and demographic data or personal data regarding each member. The member data is organized to a data structure such as data base. An e-mail communication is prepared and a command sequence including a hyperlink to a first web site and referral communications data packet associated with the hyperlink is embedded in the e-mail. Upon actuation of the hyperlink by the member, the referral data packet is sent to a second web site. The referral data packet includes one or more data elements such as sponsor data, recipient member data, e-mail campaign data and sometimes action member data. The computer-based method of communicating prepares a list of members and broadcasts the communication to members based upon the list. A report is made of the receipt of referral communications data packet. The method of communicating can be enhanced to encompass a multi-modal method of communicating wherein some members have pagers, cellular telephones and/or land-line telephones. If some members do not respond to the initial e-mail communication, the computerized multi-modal method generates a digital version of an audio communication (to be presented over the cellular telephones and land-line telephones) and a paging message (to be presented to pagers) and to fax machines.

This is a regular patent application based upon and claiming the benefit of provisional patent application serial No. ______, entitled Electronic Marketing System and Method, filed on Dec. 30, 2000, and provisional patent application serial No. ______, entitled E-mail Communications System, Method and Program, filed on Jan. 10, 2001.

The present invention relates to an e-mail communications system, method and program, and particularly an Internet-based method of communicating via e-mail and a multi-modal method of communicating via e-mail and other communications devices.

### BACKGROUND OF THE INVENTION

E-mail communications to a plurality of individuals, companies and institutions (herein “users” or “members”) is a common way of communicating information. If the users or members are grouped together in an organization such as a fan club or a common marketing system (for example, a multi-level marketing group), it is helpful to utilize a system which easily compiles a listing of members, wherein the sponsor (the originator of the e-mail communication) can easily edit the communication, create a web page for the communication, and solicit responses from its members. Further, if the users or members are part of an organization which requires quick response (for example, a political campaign or an emergency disaster recovery team), it is helpful to have a system which can initially seek contact with the members of the campaign or emergency team via e-mail and, if that communication attempt fails, mount further attempts to communicate to non-responsive members via other communications devices (such as pagers, telephones, cell-phones, etc.).

### OBJECTS OF THE INVENTION

It is an object of the present invention to provide an e-mail communications system, method and computer program.

It is another object of the present invention to provide an Internet-based method of communicating with a plurality of members wherein each member has a computer based communications system or device with an e-mail facility.

It is an additional object of the present invention to provide, in one embodiment, a multi-modal method of communicating with a plurality of members wherein each member has an e-mail facility computer system and some members utilize pagers, cellular telephones and/or land-line telephones for communication.

It is an additional object of the present invention to create, in one embodiment, an e-mail communication and embed in that e-mail communication certain HTML (Hypertext Marked-up Language) commands which, upon actuation by the e-mail recipient or member, cause the recipient to be transferred to another web site and which command generates a referral data packet or receipt data indicating that the intended e-mail recipient (addressee) has received, opened and activated the hyperlink to the first web site.

It is a further object of the present invention to provide a multi-modal method of communication, in one embodiment, which, in the absence of receipt data (indicating that the e-mail recipient or member did not receive and activate the hyperlink in the e-mail), generates a digital version of an audio communication for cellular telephones and land-line telephones and a paging message for those members having pagers and broadcasts those additional communications packets over those additional communications channels (i.e., telephone networks, cell phone networks, paging system networks, etc.).

It is another object of the present invention to provide, in a further enhancement of the present invention, a random drawing program which randomly selects one or more members as winning members in order to stimulate member activity.

### SUMMARY OF THE INVENTION

The Internet-based method of communicating interacts with a plurality of members each having a computer-based communications system with an e-mail facility. The method of communicating, in one embodiment, includes a web-based user interface for data input of member data by a plurality of members. The member data or profile includes communications data, which includes a respective e-mail address for each member, and demographic data or personal data regarding each member. The member data is organized in a data structure such as data base. An e-mail communication is prepared by the sponsor or owner of the data base. Embedded in the e-mail communication is a command sequence including a hyperlink to a first web site and referral communications data packet associated with the hyperlink such that, upon actuation of the hyperlink by the member or other user, the referral data packet is adapted to be sent to a second web site. The referral data packet includes one or more data elements from the group including sponsor data (typically the originator of the e-mail communication), recipient member data, e-mail campaign data and sometimes action member data. The computer-based method of communicating prepares a list of members from the data structure based upon criteria therein. The e-mail communication is broadcast to members based upon the listing and a report is made of the receipt of referral communications data packets. In a further enhancement, the system extracts data elements from the referral data packets and adds one or more of the data elements (or representative indications thereof) to the data structure in order to monitor the response of the membership to the e-mail broadcast. The method of communicating can be enhanced to encompass a multi-modal method of communicating wherein some members have pagers, cellular telephones, fax machines and/or land-line telephones. If some members do not respond to the initial e-mail communication (noted by the absence of receipt data or a referral communications data packet or related elements in the data structure), the computerized multi-modal method generates a digital version of an audio communication (to be presented over the cellular telephones and land-line telephones) and a paging message (to be presented to pagers). The digital version of the audio message and the paging message is sent via the Internet and associated telecommunications network (e.g., cell phone networks and pager networks) to the non-responsive members. A further interface is provided for responsive data input by the initially non-responsive members and that responsive data from those members who respond to the second message broadcast is logged in to the data structure. If a plurality of member websites is provided and if those websites are categorized as having different priorities and if the members are categorized by priority or security levels, the hyperlinks in the e-mail communications can point the member's browser to the prioritized web site based upon the member's priority level. If the priority of websites represent different levels of information for an emergency response team and the members are part of an emergency response team, the e-mail communications initially sent to the members includes current data representing an emergency and the step of broadcasting represents a step of mobilizing the emergency response team while providing different levels of information to that emergency response team in accordance with their designated priority level. A method of monitoring the effect of broadcasting e-mail communications is also provided utilizing an e-mail communication with the embedded hyperlink and referral communications data packet. The method can also be embodied in a system utilizing a computer-readable storage device and a computer-readable medium containing computer executable code wherein the code operates, in general, as described above.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates the method of communicating and the communications system;

FIG. 2 diagrammatically illustrates one methodology of gathering member data into the data base compiled for the sponsor or the originator of the e-mail communications (the second methodology being a direct data download to import data into the member data base);

FIG. 3 diagrammatically illustrates a high level flowchart describing the input of new member data;

FIG. 4 diagrammatically illustrates a high level flowchart for validating new member or preexisting member e-mail addresses;

FIG. 5 diagrammatically illustrates the system and method of communicating and various functional aspects for the e-mail communications system provided to the sponsor or e-mail originator;

FIGS. 6 and 7 diagrammatically illustrate the e-mail communication, the embedded hyperlink and associated referral data packet and, in FIG. 7, member action data ultimately reported to the sponsor;

FIG. 8 diagrammatically illustrates the receipt of referral communications data by a reporting web site and a subsequent report to the sponsor web site or to the central server; and,

FIGS. 9A and 9B diagrammatically illustrate a high level communications program flowchart for the multi-modal method of communicating and related system.

### DETAILED DESCRIPTION OF THE PREFERRED EMBODIMENTS

The present invention relates to an Internet-based method of communicating and specifically establishing an e-mail communication system which monitors responses by e-mail addressees or members. The invention also relates to a multi-modal method of communicating which expands the communication system to telephones (cellular and land-line telephones) and pagers and fax machines if the initial e-mail fails to generate a response from designated members.

The invention may be utilized by a variety of organizations. The following Exemplary Utilization Table lists some organizations which may benefit by the present method, system and computer program.

Exemplary Utilization Table 1.0

Fan Clubs (sports teams, individual players)
Celebrity Fan Clubs
Group Activity Fan Clubs
Lottery
Entertainment (e.g., Jazz Club of N.Y.C.)
Business Opportunities

Multi level Market (e.g. AMWAY)

B-2-B or B-2-C Business

Special Retail Consumer Clubs

(American Automobile Association, AARP)

Special Business Associations

(Florida Bar, Rotary Club)

Direct to Consumers

(Amazon.com)

Direct to Businesses

(Dell Business Computers)

Political Campaigns
Disaster Recovery Teams
Military Campaigns

Throughout the description of the present method and system, abbreviations are sometimes utilized describing certain features. The following Abbreviations Table lists these items.

Abbreviations Table

| | |
|---|---|
| # | number or record number |
| add | address, typically e-mail address, but sometimes |
| | mail address |
| Admin | administrator |
| ASP | Applications Service Provider or a program |
| | maintained by an Applications Service Provider |
| comm. | communications |
| config. | configure (re-config is reconfigure) |
| cpu | central processing unit |
| DB | data base or spread sheet or data array (DB1 is |
| | database 1, etc.) |
| fax | facsimile |
| id | identify, usually the member record number or |
| | sponsor record number |
| I/O | Input-Output device (e.g., I/O for keyboard, modem |
| | etc.) |
| instn. | instructions |
| M1, M2 | member 1 or member record 1, member 2 |
| mem | member |
| mess. | message or messages |
| org. | organization |
| pg. | page, typically an electronic page viewable with |
| | browser software |
| pgm. | program or routine |
| ph | phone |
| rcd | record or records (rcds) |
| req'd | required |
| sp | sponsor, typically the owner of a database and |
| | organization having control over a specific ASP, |
| | e.g., ASP 1 and DB1 |
| stats | statistics |
| Sys. | System |
| t | time |
| Tel. Comm. Center | Telecommunications Center with voice |
| | communications |
| Tel. Comm. Sys. | Telecommunications System |
| tele | telephone |
| yr | year |
| Y/N | Yes/No-user selects correct answer |

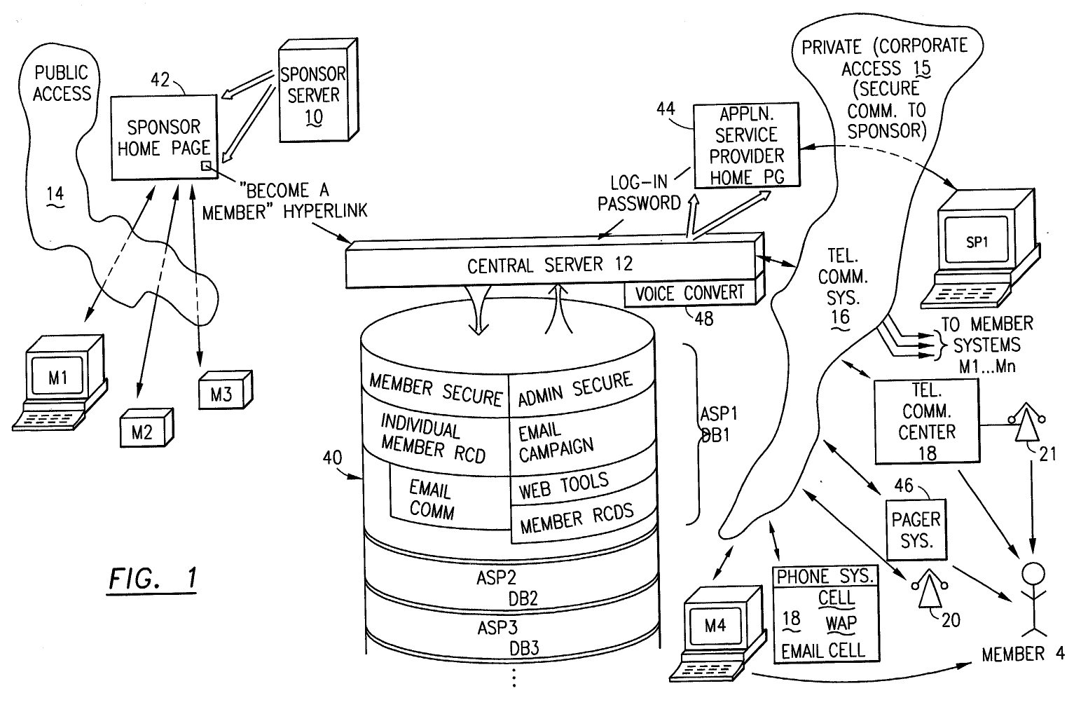

The system and method of the present invention generally operates in conjunction with the global telecommunications system or Internet which enables communication and data transport between a plurality of relatively independent computer systems (see central server 12 and member systems M1, M2, M3 and M4 in FIG. 1). These independent computer systems include browser software (that is, a computer program) which enables the user M1 or SP1 (sponsor 1 computer system) to view and interact with programs provided over the Internet. The program operable in conjunction with a user's browser software is provided and supported by computer servers such as sponsor server 10 and central server 12 in FIG. 1. Each computer system and server system typically includes a monitor (with which a user views the browser display output, among other things), an input device such as a keypad or mouse, and a processor unit or CPU. Computer server systems 10, 12 are more complex than member computer systems. The processor unit operates in conjunction with memory units and an input/output or I/O device which is coupled to the monitor, the input devices and other peripherals (such as a printer). The memory typically includes many types of data storage devices such as a hard drive, volatile and non-volatile memory (RAM and/or ROM), and removable data storage devices or drives. Also, the input/output or I/O is coupled to the Internet (that is, the I/O includes a modem or a DSL communicator or cable linking device). Member computers M1, M2, etc., may be laptop computers which can be easily disconnected from the Internet. Central server 12 is also an administrative computer which assists in the overall control and operation of the system and the method described herein. Members computers M1, M2, M3 and M4 are “user” computer systems operated by members who are individuals who interact with the central server 12 and the member database stored therein. Sponsor computer Sp1 represents one or more computers operated by persons or organizations that have supervisory access or control over a particular application (ASP1, ASP2, etc.) or member data base program and campaign manger program provided or supported by the central server 12 via an ASP or an Application Service Provider. Different sponsors have different access to different ASPs and different data bases on central server 12. See, for example, ASP1 operates in conjunction with data base or DB1, ASP2 and DB2 operates independently of ASP1 and ASP3 and DB3 is different compared to ASP1 and ASP2. Each sponsor, Sp1, Sp2, and Sp3, in the preferred embodiment owns and controls its own database and operates its own ASP as described herein. Computer hardware is typically common to all ASPs. It should be noted that a distributed computing system, replacing central server 12, may be utilized. Also, a sponsor may run its ASP on its own server, e.g., sponsor server 10. In this case, the ASP is linked to the data base on sponsor server 10.

In a preferred embodiment, the system and method are deployed over Internet 14, 15 and telecommunications system 16 via computer system server 12. Internet 14 is differentiated from Internet 15 because communications system 14 is public or available to all but communication system 15 is a secure communications link (e.g., an SSL or secure socket link) between server 12 and client-sponsor computer SP1. Specific member data from M1 may be obtained via a secure communications channel such as SSL. Server 12 includes a CPU, memory and an I/O and a voice to data and data to voice converted, and server 12 is coupled to Internet 14,15 and telecommunications system 16.

In an enhanced version of the present invention and with respect to an enhanced data output, e-mail communications systems and campaign manager systems or methods may operate in conjunction with a telephone telecommunications center 18. The telephone telecommunications center typically includes one or more computers and one or more telephones. Human operators are provided with scripts or displayed data and the operator's phone automatically calls phone numbers on a phone list for members to activate the marketing or communications process of the present invention. The telecommunications center 18 automatically dials the telephone number of the member. The output of digital information from central server 12 is fed to telecommunications center 18, operator information is displayed as needed, and the Tel. Comm. center 18 calls members based upon the data download or export from the central server 12. Information to member M4 can be delivered or facilitated by a person at telephone communications center 18. For example, the computer in center 18 could display data which the operator could audibly present via telephone to member M4. The operator at telecommunication center 18 inputs into his or her computer the member's answers or response and center 18 generates appropriate responses to complete data entry forms ultimately sent to the central server system 12. A browser based system may be utilized in telecommunications center 18. The data base in server 12 is then altered to reflect member M4's answers or responses. Central Server 12 may also contact member 4 (shown as a stick figure in FIG. 1) via a pager system, telephone system 18 or client-member computer M4, via telecommunications system 16. Direct voice communications with telephone 20 to member M4 is also available via system 16. Member 4 can input data via DTMF key pad on phone 20. Voice data from member M4 is converted into a digital format via voice recognition into server 12.

With respect to data input, in a preferred embodiment, member data is initially obtained by utilizing a web browser or other type of interface on a member's computer M1 (for example), which is called, in the computer arts, a “client” computer. The client computer interacts with one or more server computers, such as server 20. The browser program is supported by an ASP program on server computer. The information obtained from computer M1, M2, etc., is generally stored in server 12. Thereafter, the information is processed by server 12 and the output information representing processed data is delivered to the sponsor via Internet 15, and ultimately to the client computer operated by the sponsor, Sp1.

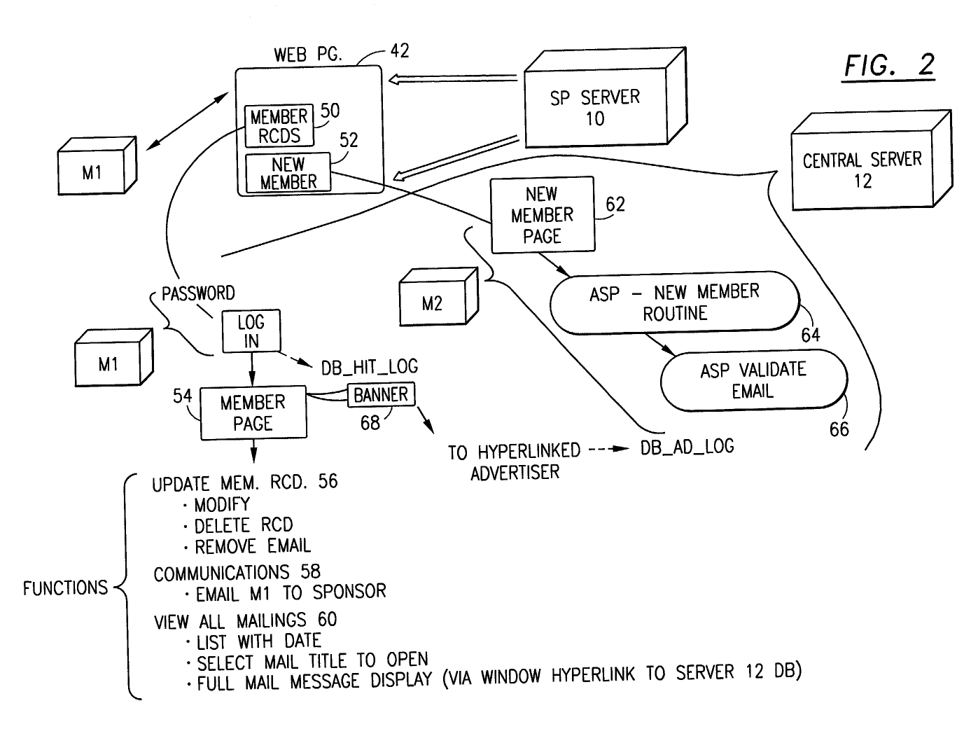

FIG. 1 diagrammatically shows web-based sponsor sever 10 deploying a screen display or web page (Sponsor Home Page). The member M1 accesses the sponsor's home page and, when the member “clicks on” or selects the “become a member” link or “access your member profile” link (see FIG. 2) on the sponsor home page, the member's computer, e.g. M1, is hyperlinked or transferred to central server 12. Certain member data, input by a user at computer M1, is returned to server 12. In this manner, servers 10, 12 transmit information to a web browser on user's client computer M1 and that information is displayed to the user. When the user inputs information, that data, such as member profile data (discussed later), is sent back to server 12 to be processed. Output information is provided by server 12 to the user's browser in system M1. In this manner, the computer system and method of the present invention is a web-based server. With respect to communications data output, typically this output to client-member computers M1, M2, M3 and M4 is an e-mail communication from central server 12 to the member computers. E-mail communication campaigns are managed via a unique ASP by the sponsor via client-sponsor computer SP1. Computer SP1 represents many sponsors and many sponsor computers have access to a particular ASP.

The browser is displayed on computers M1, M2, etc. and Sp1 or is displayed on an Internet enabled, computerized device such as a PALM PILOT or Internet enabled cellular telephone. The browser and web server may be considered part of the interface to the data and information processing system of the present invention.

The present invention can be produced in hardware or software, or in a combination ofhardware and software, and these hardware and software implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means (such as a local or widely distributed network over a telecommunications system), as would be known by one of ordinary skill in art.

According to the inventive principles as disclosed herein, the invention and the inventive principles are not limited to any particular kind of computer system but may be used with any general purpose computer, as would be known to one of ordinary skill in the art, arranged to perform the functions described and the method steps described. The operations of such a computer, as described herein, may be according to a computer program contained on a medium for use in the operation or control of the computer, as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The communication system, as generally diagrammatically outlined in FIG. 1, first obtains information from a plurality of members. Typically, membership information is input into the communications system, and particularly into one of the data bases, DB1, DB2, DB3, DB n and database or data structure 40 independently by each member M1, M2, M3, M4, M n. However, the member information could be uploaded into the data structure (a database or a spreadsheet or other organized compilation of data) and specifically into database DB1 by other mechanisms such as an export of a preexisting list of members wherein the preexisting list of members includes member data and lists including communications data, e-mail addresses and some type of identification for each member. This information could be obtained via telecommunications center 18 or via an electronic transfer directly into database DB1 from a similar member list or database. Typically, the sponsor or organization owning the data and the data base, publicly post a sponsor home page or web site with many web pages linked together. This web site is accessible to a wide number of members via Internet 14. In most situations, members voluntarily input member information or member data into database DB1 via an ASP from central server 12 by clicking on the “become a member” hyperlink on sponsor web page or web site 42. The member, in the current embodiment, has access to his or her own membership records such that the member can edit those records as necessary. This is shown in connection with data base 1 and application service provider program 1. Also in a preferred embodiment, the communications link between the member at computer system M1 and central server 12 and database DB1 is secured through a secured socket link (SSL). The sponsor, for example SP1, has a unique application service provider program ASP 1 and is the owner of the data and database or DB1. Sponsor at sponsor's computer SP1 accesses data base DB1 on central server 12 via the Internet access 15. Internet access 15 is password controlled and is a secure communications channel. Currently, the sponsor accesses data base DB 1 through the ASP web site 44. The user at sponsor computer SP1 must input a login command (designating the sponsor's identity) and a password (unique to the user of SP1) in order to access the particular database and application service provider program. Accordingly, the user at SP1 can only access ASP1 and DB1. The user at SP1 cannot access SP2 or DB2 or any other application service provider program. A high degree of security is provided. The present Internet-based method of communicating is a highly sophisticated marketing and advertising solution. It enables the sponsors or businesses to attract, register members, and communicate directly with members and consumers through the Internet. The system provides a secure e-mail marketing program and e-mail marketing campaign services to the sponsor. In a preferred embodiment, the method of communication is completely Internet-based or server-client computer-based. In other words, the sponsor accesses ASP1 and database 1 via a web browser interface. Members M1, M2 etc., access their individual member records and e-mail communications via a web browser. The system enables the sponsor to build and maintain a highly detailed database of members and to deliver personalized e-mail communications to its members. By purchasing additional member data from other providers, the sponsor can target non-members utilizing the same e-mail marketing campaign methods. The system, as described later, monitors the response of broadcasting e-mail communications. Accordingly, the sponsor can quickly monitor the effects of the e-mail campaign.

The member has a high degree of control over his or her information in the member record database DB1. The member can customize the kind and amount of information present in the member record database. For example when the sponsor is a lottery and the data base is a loyalty club for the lottery, the member data may include options, selectable by the member, indicating whether the member wants to receive notification of winning lottery numbers, jackpot amounts, newsletters, special promotions and whether the member wants to participate in surveys regarding new products and new product promotions. From the data base DB1, the sponsor utilizes a specially configured application service provider program sometimes called herein a “campaign manager,” as a management tool. The campaign manager enables the sponsor to develop and implement direct marketing e-mail campaigns. The campaigns can be deployed either through e-mail or postal delivery (via the export routine) based upon production of a mailing list further based on such criteria input by the sponsor into the search engine for the data base. The member record may also include a provision enabling the member to select how the member will receive these communications from the sponsor.

Outputs from the e-mail campaign are sent via telecommunications system 16 which typically includes the Internet to member systems M1, M2 . . . Mn. In an enhanced mode involving a plurality of communication systems, the members may be notified by a telephone communication center 18 via land-line telephone 21 (see member 4), pager system 46 or cellular phone system 18. In this situation, central server 12 includes a voice conversion sub-component 48 which converts the digital version of the audio communications as necessary to transmit the audio message to member 4 via telecommunications system 16. Telecommunications system 16 includes telephone lines, optical cable lines, network communications and other communications channels. As described later, a communication channel is initially sought to be establish with member 4 via member 4 computer-based communication system M4.

Similar numerals designate similar items throughout the figures.

FIG. 2 diagrammatically illustrates the data input into the system of the present invention via the Internet. Sponsor web page 42 is publicly provided via sponsor server 10 over the Internet. Tables 2.0 and 3.0 list some functions available to visitors at sponsor web site 42. The sponsor's main web page includes internal links to sub-ages with the identified data.

Main Web Page (Example: Sponsor: Fan Club) Table 2.0

Fan Club - I'd like to get to know you (New Member Routine)
Photo of the Month
Current News
Historic Facts about Celebrity - Fan Club- Sports Team
FAQs (frequently asked questions)
Member Log-in

Main Web Page (Example: Sponsor: Lottery) Table 3.0

Lottery Historic Information
Use of Lottery Proceeds
Game Rules
Game Results (daily, weekly, combinatory)
Winners
Special Events
Membership Club (V.I.P. Club)
FAQs

In a typical embodiment, the member, in FIG. 2, member M1, can select a hyperlink for the member records or, if the user on computer system M1 is a visitor and is an incipient or potential new member, the user can select the new member hyperlink from sponsor web page 42. Typically, upon selection of the member record hyperlink 50, the user at computer system M1 is prompted to input a password and to login. Typically, member records are maintained on central server 12. When member M1 logs into central server 12, an electronic annotation is made to the data base in the data base hit log. Hence, the member records in data base DB1 maintains a frequency count for the number of times the member has accessed his or her member record. The member is then transported to a member page web site 54. This is part of ASP1 and DB1 on server 12 in FIG. 1. The member page web site typically includes the following functions: (a) update member record 56 which enables the user or member to modify the member record, delete his or her record, or remove the e-mail; (b) communications function 58 which enables the member to send e-mail to the sponsor; (c) view all mailings function 60. The view mailings function 60 provides a list or display to the member of all e-mail communications sent to the member by the sponsor (chronologically). The member is permitted to select one or more of these e-mail communications to view the mailing. Upon selection, the full e-mail message is displayed to the member. This is typically done via a window hyperlink on server 12 to an e-mail file and particularly to the data base unique to that sponsor.

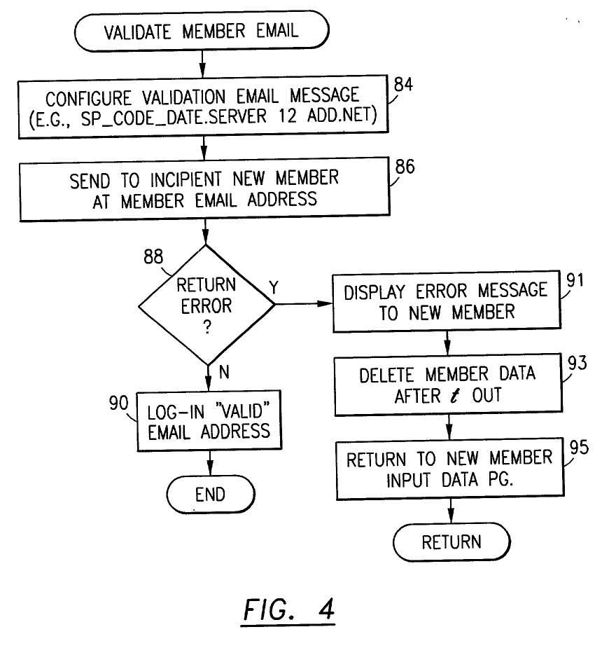

If the person or user selects new member hyperlink 52, the user is transported to a new member web site page 62. In FIG. 2, the new or incipient member is on member computer M 2. The new member web site page 62 then activates the application service provider program ASP new member routine and subsequently the ASP validates e-mail program 66. Validation of e-mail addresses is discussed later in FIG. 4.

Returning to member page web site 54, the member M1 can select ad banner 68 which transports the member to the hyperlinked advertiser. Further, the data base is annotated in the advertising log when the member M1 clicks on the ad banner. This monitors the response to banner advertising in the member data base.

The present e-mail communications system begins with a customer or member data base, which can be built from an existing customer or member file, return addresses on second chance drawings, mall intercepts and even point of sale surveys. Customers or members can also add themselves to the data base when the members access the company or sponsor web site and complete a simple registration or loyalty club form. By registering, the customer is given the option of telling the sponsor what kind of information the customer or member would like to receive.

The e-mail communication system can also be expanded to include business partners, suppliers or vendors which fill out a member profile form. The member profile form is specifically designed for the customer, fan club or business. Typically, the member profile form includes specific information such as e-mail addresses, name, address, telephone number and fax numbers for the member or business partners. The member profile form can also include a survey and opt in e-mail request. the member data is stored in a secure data base DB1 and typically, the sponsor owns the data in the data base. The following Member Profile Data Table 4.0 shows typical information for a fan club or a consumer.

Member Profile data Table 4.0

e-mail address
Password
Name
Address
City
State
Zip code
Country
Birth Date
Gender M/F
Annual Salary

(Range $15,000; 15,000-25,000; 25,000 - 35,000 etc.)

Education (select from menu)
Marital Status (select from menu)
Hours of Internet use per day (select from menu)
How did you hear about site (select from menu)

(friend, TV, radio, magazine, etc.)

Have you bought products or services on line Y/N
Do you have a credit card Y/N
Radio YES/NO buttons (default to YES)
Do you want to know of other sites
Do you want to know of special events
Do you want to know of special offers
What games do you play (Lottery games, amount of wager)
What magazines do you subscribe to
What newspapers do you read (daily, weekly)
Frequency of visit (purchase/attendance (e.g., frequency of purchase
of Lottery tickets)
Special Event Notification (i.e., concert, Lottery exceeds
$5,000,000.00)
Subscribe to Newsletter Y/N

Once a person becomes a member of the sponsor's data base, the member is sent numerous communications from the sponsor and the member has the ability to track all e-mail communications between the sponsor and the member. Further, the member has full access to his or her consumer or business profile and the member can manage his or her own data throughout of any or all e-mail communications. On-line forms integrate processes with the sponsors business needs to existing e-commerce solutions. Access to any form, page or web site can be added to the member's program with relative ease.

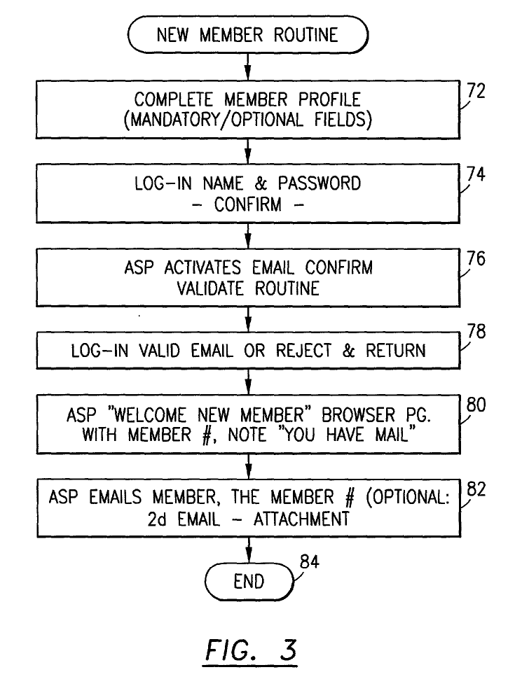

FIG. 3 diagrammatically illustrates a flowchart for the new member routine. In step 72, the member completes a member profile. See Member Profile Table 4.0. In step 74, the member selects his or her own password. There are certain fields in the member profile data form that are mandatory and other fields that are optional. Optional fields need not be completed by the member. In step 74, the user selects a password and user login name. The system confirms the password by requiring double entry by the member. In step 76, the ASP activates the e-mail confirm validate routine. This is discussed later in connection with FIG. 4. In step 78, the system logs in the valid e-mail or rejects and returns an error message to the member. If the e-mail address input by the member is inaccurate, an error message is immediately presented to the incipient member. In step 80, the ASP provides a “welcome new member” web page to the user and further sends a welcome new member e-mail to the user. The web page includes the members' number or I.D. number and indicates that the member has e-mail. In step 82, the ASP program e-mails the member, sending the member his or her member number, and optionally sends a new member communications with an attachment such as an illustration of the celebrity. The system ends in step 84.

As described above, the system validates the e-mail address input by the member into the system. FIG. 4 diagrammatically illustrates the major components of this routine in flowchart form. Step 84 configures or generates a validation e-mail message to the member's e-mail server That message typically includes an e-mail address directed to the member at his or her e-mail address. The return address or addressor's information block includes the sponsor code and the date and includes an address which identifies server 12 as a network. In step 86, this validation e-mail message with the special addressor information is sent to the incipient new member at the member's e-mail address. Decision block 88 determines whether there is a return error from the member's e-mail service provider. If not, the NO branch is taken and the system in step 90 logs in as valid the member's e-mail address. In other words, in the absence of a return error message from the member's e-mail server, the communications system of the present invention assumes that the e-mail address is proper and logs in that e-mail address as valid.

If the communication system at server 12 receives an error message from the member's e-mail server, the YES branch is taken from decision step 88 and, in step 91, an error message is displayed to the incipient new member. In step 93, the system deletes the member data after a certain time out period. The time out period enables the member to input the correct e-mail address. In step 95, the system returns to the new member input data page.

As stated earlier, the member information collected in the member data base is typically obtained and processed through a secured socket layer (SSL) that results in all data being encrypted as it passes over the Internet. This feature ensures that personal information of the member provided over the Internet to ASP1 running on client server 12 is maintained in confidence and is captured in secured mode.

The validate member e-mail routine, discussed above in FIG. 4, is activated upon data entry. If the member e-mail address is not active or is formatted incorrectly, the communications system will notify the member with a prompt to repair the data entry error. Further, the capability of the member's computer system to display HTML based e-mail is verified upon registration. If the member's system is unable to display HTML e-mail, the communication system notes this automatically and will only send text based e-mail through the system. Further, members capable of receiving HTML e-mail can elect to receive only text based e-mail. Text based e-mail does not provide a referral data packet response.

In an enhanced embodiment, other required fields in the member data profile are validated. Filtering technology is utilized to insure that the data entered by the member meets data type requirements.

Once the member has successfully completed the member profile form, a welcome message is immediately dispatched to the member by e-mail. The sponsor selects and controls the content of the message and the graphics for the welcome greetings. When members return to the web site and enter sponsor web page 42, and those members activate member records 50, the members are greeted with a welcome message composed by the sponsor. Sponsors can add new news items, with graphics, web links or hyperlinks, and have the ability to create numerous types of e-mail campaigns, such as “refer a friend” campaign, through the campaign manager program discussed later. Further, a member's view of the sponsor's web site 42 can be tailored to fit the information provided on the profile form. For example, if a celebrity has younger fans, age 12-18, and a different group of older fans, age 30-35, and the celebrity wants to create a different impression for the younger fans as compared with the older fans, the member, when signing on to sponsor web page 42 (FIG. 2), and particularly member record hyperlink 50, may be transported to different web pages dependent upon the member's data which is represented by the referral data packet and associated hyperlink. The older members may be transported to an “old member” web site or web page uniquely customized to his or her preferences, as a demographic group with all other older members. In contrast, the younger members, age 12-18, would be transferred to a different web site that provides different information unique to that demographic member group. Hence, the view of web page 54 in FIG. 2 represents one of many views dependent upon the complexity and the configuration of the ASP as designed by the sponsor.

Once the sponsor's data base is populated with member profile information, the sponsor is enabled to conduct direct marketing campaigns using a computer program generally identified as a “campaign manager” herein. Since, in the preferred embodiment, the program of the present invention is implemented on the Internet, the sponsor must have access to the Internet in order to develop the e-mail campaigns, manage the campaigns and view the results of the campaign. With the campaign manager program, the sponsor defines the parameters of the campaign by conducting a search through the member records based upon criteria encompassed in the member records. After the search and compilation of a listing of members from the data base, the system generates personalized, permission based e-mails (in a preferred embodiment), and enables the sponsor to tract the progress of the campaign. The e-mail marketing campaigns can be established periodically such as weekly, daily, or for special events such as birthdays, monthly newsletters, special announcements, new product launches, special events, custom surveys and other type of communications. With a fully performing campaign manager program, the sponsor can create (1) dynamic e-mail messages using text, HTML (hypertext marked-up language), graphics and other objects; (2) send e-mail communications based on member preferences; (3) create and broadcast targeted mass e-mail campaigns (currently at a rate at or exceeding 100,000 e-mails per hour); (4) utilize the member data base to insure loyal customers and members are aware of new products to the sponsors; (5) manage, select and send e-mails or other communications (including direct land-based mail) to your “best” members; (6) create a referral URL (Universal Research Locator) program to tract responses by members to the sponsor's advertising banners on remote sites, that is, remote web site; (7) track response rates and analyze response results for fast, economical, on line focus groups; (8) edit member's profile at their request in order to build stronger relationships with the members, customers or business partners by satisfying their needs and anticipating their requirements; (9) test the effectiveness of a promotional communication campaign through e-mail before spending valuable marketing funds on a direct mail promotion; (10) export data from the member records to flat file (spreadsheets) to conduct direct land-based mail campaign for non-e-mail enabled members; (11) conduct special giveaways for registered members through a random drawings features and routines; and (12) conduct cooperative promotions with other businesses and demonstrate how the sponsor's ASP can drive customers to the two coop sponsors.

The communications program and system, and particularly the campaign manager, enables the sponsor to establish user parameters that allow authorized sponsor employees to create, edit and approve and execute an e-mail marketing campaign. User friendly reports allow authorized personnel of the sponsor to view the message, the number of people or members receiving the message, the cost of the e-mail campaign, all before the e-mail campaign is executed. In addition, the sponsor has the option of sending the e-mail campaign to a select or test group of members. Hence, the sponsor can analyze the member responses before the full blown e-mail campaign is sent to the entire member group.

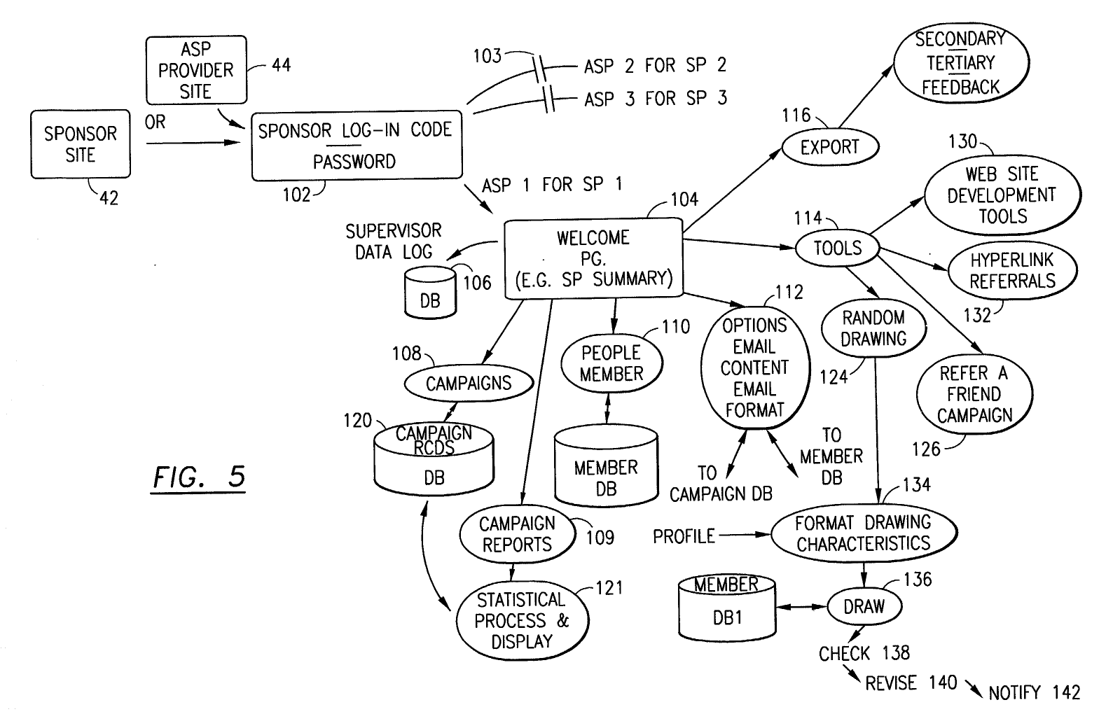

FIG. 5 diagrammatically illustrates the campaign manager for the communications system. In general, the campaign manager resides on central server 12 (FIG. 1) and is represented by application service provider program ASP1 and data base DB1. Different ASPs utilize different data bases. For example, Maryland Lottery utilizes ASP1 and data base 1 whereas Texas Lottery is ASP2 and DB2.

An authorized user on sponsor computer SP1 (FIG. 1), can access the campaign manager ASP1 via sponsor cite 42 (FIG. 5) or ASP provider site 44 (FIGS. 1 and 5). In any event, the authorized user at SP1 computer system presents a login code indicating the sponsor and a password identifying the user in functional block 102. Access to ASP2 and ASP3 is blocked as shown diagrammatically by the double line block illustration 103. If the sponsor login code and user password in function block 102 is acceptable to ASP1, central server 12 generates a welcome page for the user at SP1 in function block 104. After this welcome screen 104 or concurrent with welcome screen 104, the user at SP1 is presented with, in a working embodiment, a sponsor summary screen. The following Table 6.0 shows a Sponsor Summary Screen for a Lottery.

TABLE 6.0
Sponsor Summary Screen (e.g., Lottery)

| | | |
|---|---|---|
| Birthday Recognition | | |
| Copy of Template for Birthday Recognition | Send | Sent 0 |
| Template for Birthday Recognition | Send | Sent 0 |
| Co-Promotions | | |
| Copy of Merriweather Promotion | Send | Sent 0 |
| Merriweather Promotion | Send | Sent 1967 |
| Export | | |
| Bingo Survey Final | Send | Sent 248 |
| Counting Crows concert ticket winners | Send | Sent 36 |
| Game Promotions | | |
| No mailing defined | | |
| Holiday Greetings | Send | Sent 0 |
| 4^{th} of July 2000 | | |
| Jackpot Reminders | | |
| Big Game Jackpot Alert-July 27, 2000 | Send | Sent 2233 |
| Jackpot Reminder Template | Send | Sent 2 |
| Lotto/Big Game Jackpot Alert-June 12, 2000 | Send | Sent 1235 |
| Letters to Winners | | |
| You just won tickets to Rocky Gap! | Send | Sent 9 |
| You just won tickets to the Creed Concert! | Send | Sent 26 |

The sponsor summary screen shows major communication campaigns, and in the illustrated embodiment, major e-mail marketing campaigns and specific e-mail campaigns. Hence, the “birthday” general e-mail marketing campaign is a template for birthday recognition communications as is the initial e-mail marketing campaign. The general campaign entitled “Co-Promotions” is further identified as Merriweather Promotion. Other organizational formats may be utilized for the summary screen showing major communication campaigns. As described later, rather than a marketing campaign, the sponsor may be a political organization organizing a political campaign to affect a piece of legislation or promote a particular candidate for public office. Also, the present communications system may be utilized by public service organizations and particularly disaster recovery teams or the military. In this sense, the sponsor summary screen would include various listings for various disasters, such as hurricanes, tornadoes, multiple unit fires, riots and further list specific communications campaigns under each one of those major categories.

In a working embodiment, the user at SP1 is presented via his or her browser and ASP at central server 12 functions to manipulate the campaign and process the results of the campaign. The following Functions Available Table 6.1 provides some examples for a working embodiment.

Functions Available Table 6.1 on Welcome/Summary Screen

Summary of Campaign
Campaigns
People (Member Records)
Campaign Reports
Options
Tools for Web Site Development
Help
Support

In general returning to FIG. 5, the user via the computer browser on client computer SP1 can request various routines from the web server at central server 12 including viewing supervisor data log 106 (which permits the authorized user to view all supervisors who accessed ASP 1), campaign routine 108, people or member routine 110, options routine 112 (which establishes e-mail content and e-mail format), tools routine 114 and export data routine 116. Help and Support routines shown on Table 6.1 provide on-line assistance to the user at client computer SP1 and other voice assistance via a support line from other telecommunications links (such as e-mail, telephone support etc.).

If the user at SP1 selects the campaign function and the campaign function 108 accesses campaign records 120. Campaign records 120 are stored in a data base particularly located in FIG. 1 as DB1. Campaign record data base 120 is generally associated with the e-mail campaign segment identified in FIG. 1 at DB1.

The user at summary screen 104 may also select campaign reports function 109. Campaign reports function 109 calls up and executes statistical process and display functions 121. Statistical process functions 121 operate in conjunction with campaign record data base 120.

In a specific, working embodiment, when the user at SP1 selects the campaign function 108, the user is presented with a screen display having function shown in Campaign Details Table 7.1 which follows.

Campaign Details Table 7.1

A: Select: Summary of Campaigns
B: Select: One Specific Campaign

Routine Functions Available: General - HTML Mailing Edit --
Text Mailing Edit - Send - Tools - Save
Major Functions Available - See Functions Table 6.1

C: Routine Open: General

Functions: same as element B
Displayed Fields

Name of Campaign (e.g., Merriweather Promotion)
Description of Campaign (e.g., Merriweather Summer 2000)
From Name: Sponsor's Name
From Address: Sponsor's e-mail address at server 12 network
Subject: Promotion Summer 2000

D: Routine Open: HTML Mailing

Functions: same as item B
Display e-mail in editable web browser format
Edit Functions Available:

cut, copy, paste, undo, tet select, font size, font characteristic
(e.g., bold), outline tools, icon and image insert tools

Scroll bars available: vertical and horizontal
Major Functions Available: See Functions Table 6.1

E: Routine Open: Text Mailing

Functions Available: Preview
Major Functions Available 6.1
Display: Text of e-mail communications

Table 7.1 at element A indicates that the user at SP1 has selected “campaign.” Table 7.1 at item B indicates that the user at SP1 has selected a specific campaign. The routines or functions available when the user at SP1 has selected a specific campaign are “general,” “HTML mailing,” “text mailing edit,” “send,” “tools,” and “save.” Under the general heading, as shown on Table 7.1, element C the user at SP1 is shown the same functions as in element or item B. However, the user when the “general” function is opened is shown or displayed fields indicating the name of the campaign, the description of the campaign, who the e-mail campaign was sent by, the address of the campaign sender and the subject line of that e-mail campaign. Typically, the “from address” is the addressor's or sponsor's e-mail address at ASP1 on central server 12.

If the user at SP1 opens the “HTML mailing edit” function as shown in element D in Table 7.1, the user is exposed to the same functions as shown in the Major Function Available Table 6.1 and the routine functions available shown in element B in Table 7.1. However, when the “HTML mailing edit” function routine is opened, the display shows the proposed e-mail communication in HTML format as an editable web browser format. Additionally, the user is presented with basic edit functions such as cut, copy, paste, undo, and other commands or functions set forth above in Table 7.1. In a working embodiment, other functions are available to edit the proposed e-mail communication such as establishing a number sequence, a bullet sequence, left justify, right justify, center, insert icons and others. Scroll bars are also available to permit the user to move throughout the HTML e-mail document. Major functions shown in Table 6.1 are also available to the user when he or she opens the HTML mailing edit function routine.

When the user opens the “text mailing edit function” routine, Table 7. 1, element E, the same functions are available as listed above in element B, Table 7.1 and further the user has a “preview” function. The preview function is also available for “HTML edit function” routine as element D in Table 7.1. In element E, the user is presented with a display of the text of e-mail communications. In general, elements D and E in Table 7. 1, the HTML mailing edit routine and the text mailing edit routine is generally designated on the user's screen as “update mailing.”

Once the user has prepared the e-mail communication, the user selects the “send” function identified in Table 7. 1, element B. The send function is also viewed and available at the general function level (element C) and at the HTML mailing edit function (element D) and the text mailing edit function (element E). Upon selection of the “send” function, the user at SP1 must establish which members from the member records will be sent the prepared e-mail. The following Table 7.2 shows an example of the Send Function Screens.

Campaign Details Table 7.2 (e.g., lottery campaign)

A: Path: Select Summary of Campaign, select one specific campaign
B: Routine open: Send Function
C: Functions Available: All Major Functions 6.1, -- clear -- Send Mail --

D: Display: Mailing Options

Yes (default)/No: send e-mail to members with e-mail addresses
Y/N: export delimited file for members with no e-mail addresses
Y/N: export delimited file for all members per

E: Display: Define Scope of Campaign (DB Search Criteria)

Boolean Logic and

F: Input Fields:

Who should receive a report regarding this e-mail campaign?
e-mail add; name; mail add

G: Search Criteria or Campaign Selection Criteria:

Zip Codes
State (s)
Category of member (e.g., daily lotto player, weekly player, or pre-define categories
Matching Member Data Profile categories)

H: Selection of Member Personal Information

Gender M/F
Birth Month
Income Level
Minimum Age
Maximum Age
Age Brackets (pull down menu selection)

I: Selection of Sponsor Specific Criteria

(See, e.g., Lottery Specific Criteria Table)

J: Selection of Certain Member Benefits (e-mail Acceptance by Member)

Member wants e-mail about special offers, new games, events
Member receives magazine/newsletter periodically
Member wants to participate in surveys, drawings, new products
Member wants to participate in discussion re new products

K: Exclude Random Drawing Winners

Pull down menu showing Drawing Titles

Table 7.2 shows that in element A, the user has selected summary of campaigns and then has selected a specific campaign and, in element B, the routine the user has selected and is currently operating is the “send” function routine. Element C identifies that the major functions Table 6.1 are available. Element D indicates that the display on SP1 presents the user with certain mailing options. The user can choose (via YES/NO), to send e-mail to all members with an e-mail address or to export a delimited file to members with no e-mail addresses or to export a delimited file for all members in accordance with certain search criteria. Element E in Table 7.2 indicates that the display to the user at SP1 enables the user to define the scope of the e-mail campaign. This is a database search criteria and typically includes boolean logic AND. However, other types of boolean logic operators could be utilized in the search. By utilizing boolean logic AND, the more criteria input by the sponsor-user, the narrower the e-mail campaign.

Element F in Table 7.2 requires that the user identify who will receive the report regarding this e-mail campaign. In a preferred embodiment, after the e-mail campaign and the e-mails are broadcast to the selected members, an electronic communication showing the number of e-mails sent is generated and sent to the sponsor or a sponsor's representative. Typically, the e-mail campaign is sent via central server 12 (FIG. 1) to a plurality of members M1, M2, etc. Upon successful completion of an e-mail campaign, a short e-mail is formatted by the communications system and sent to the sponsor at SP1. Of course, the sponsor may authorize that the e-mail report indicating a completion of the e-mail communications program be sent to a third party. Element F in Table 7.2 enables the user to input data regarding this e-mail report. Element G in Table 7.2 enables the user at SP1 to establish which zip code should be selected from the member data base, which members in which states, which categories of members or other selections from criteria encompassed by the data member records should be used to generate a listing of members for the e-mail campaign. Categories of members, as an example, lottery fan clubs, may include members who play the lottery daily, weekly players, or predefined categories matching member data profile categories. States may be selected based upon a pull down menu.

Element H in Table 7.2 enables the user to select member personal information in order to establish an e-mail list. The sex gender of the member, birth month, income level, minimum age or maximum age or age brackets (a pull down menu) is available. The sponsor in creating the member record data base may include specific questions unique to its membership. Element I in Table 7.2 shows that feature. The Lottery Specific Criteria Table 8.0 (discussed and set forth below) is an example of specific criteria for a lottery fan club or member club or group. A celebrity fan club would have different material. If the political campaign was the sponsor or if a government agency was the sponsor, specific member criteria may include the status of the member in the political campaign or the priority level or security level of the emergency response team. For example, doctors on an emergency response team would be provided with different information as compared with firefighters on the same emergency response team.

Element J in Table 7.2 relates to member data that is specifically identified by the member. For example, if the member wants all e-mails, and has accepted e-mail communications as an acceptable mode of communications, this data field is annotated in that manner in the member records. The member, when inputting his or her data, selects a field whether he or she wants information regarding special offers, new games or events. Further, the member identifies certain demographic or personal data by identifying whether he or she wishes to receive certain sponsor's magazines or newsletters, wants to participate in surveys, drawings or new product surveys, or wants to participate in an on-line discussion regarding new products. Element K in Table 7.2 excludes random drawing winners (discussed later). In this sense, the user selects from a pull down menu which drawings (the subject of the current e-mail) the members will be excluded from. As described later, the member record includes an indication whether that member has been a winner of a previous drawing.

Lottery Specific Criteria Table 8.0

User: Select all, some or none
Matrix: Type of Lottery (radio button selectable by user)
Amount of wager (pull down menu with bracketed amounts, e.g., $ 1,00 - $10.00)
Location: Purchase of Goods - Lottery Tickets (pull down menu, grocery stores, convenience
stores, liquor stores, etc.)

List of venues which sell lottery tickets, user selects radio buttons (include “on-line”
purchaser)

Category “How do you find information about the winning lottery number” (pull down
menu, user selects one)
Category: “How did you first learn of Member-Club? (pull down menu, user selects)
Special Categories: Notify me (member) when:

(a) event A occurs (e.g., lottery over $5,000,000.00);
(b) event B occurs;
(c) event C occurs;
(d) any of events A, B or C.

The Campaign Details Table 7.3 which follows is available to the user at SP1 when the user has selected the path (element A, Table 7.3) to select a campaign and selects a specific campaign and has opened the “send e-mail” routine (noted in element B, Table 7.3).

Campaign Details Table 7.3

A: Path: select Summary of Campaigns, select one specific campaign
B: Routine open: Send e-mail
C: Functions Available: all major functions, see Table 6.1
D: Display and output fields (sys. computes and counts rcds.)

The search/selection criteria identifies n number of e-mails

E: Display and input field

Where should start and finish e-mail notification be delivered?
-- input e-mail addresses --
Function: submit (approves data as input and data output and proposed e-mail

communication)
F: Review Selection/Matches prior to mailing

Review top n (user input number) matches from data base
Function: Review (system compiles list ranked by highest hit ratio) (user selects
“Review” function button)

G: Display: Text of e-mail message

The functions available to the user (element C, Table 7.3) list all the major functions (see Table 6.1) as well as displays certain fields. Element D, Table 7.3 provides that the system counts the number of members for the proposed e-mail campaign (n e-mails) and displays the number n of members to the user at SP1. In other words, the communications system has searched all the member records in DB1 and has prepared a listing of the members showing the number n of e-mails for that e-mail campaign. Element E in Table 7.3 indicates that the user is displayed and is provided an input field regarding which e-mail addressee should receive notification that the e-mail campaign has started and ended. Since e-mail rejections or “bounce backs” are typical, less e-mails are received than n e-mails sent out. The user is prompted to input an e-mail address. Also, the user, at the screen, is provided with a “submit” function button. If the user's clearance or security code does not meet a predetermined supervisory level, actuation of a function routine (such as “submit”) is blocked. If the user signed on to the ASP campaign manager exceeds the supervisory code status, the function “submit” is operable. Element F in Table 7.3 indicates that the user is permitted to review the selection or matches from the record members prior to mailing. The user can review the top n (for example 100) matches from the member data base. The user is also provided with a “review” function which causes the communication system to search through the member list and rank those members by the highest hit or criteria ratio. Element G in Table 7.3 indicates that the user is presented with a text of the e-mail message for his or her review.

Actuation of the submit function button causes generation of the e-mail campaign, notification of the start of a campaign to the proper e-mail address of the sponsor, broadcast of the e-mail to the selected members and subsequent notification of the completion of the campaign to the sponsor e-mail address. See element E, Table 7.3. Additionally, at the completion of the e-mail campaign, a report is generated to the sponsor's e-mail address as discussed above in element F, Table 7.2. The “review proposed mailing list” element F in Table 7.3, enables the user at SP1 to ensure that communications are not improperly sent to erroneously selected members.

If the user selects the “people” or function 110 in FIG. 5 member major function (see major function Table 6.1), the user at SP 1 is presented with a display similar to that shown below in Member Records Function Details Table 9.0.

Member Records Function Details Table 9.0

A: Path: from main page, members (people)
B: Functions Available: All Major Functions, see Table 6.1
C: Special Functions: Member Records (People) -- New (permits input of data for new member)
-- find (with input field or search term field) -- Select (system opens selected member record) --
Delete (system deletes selected member record) - Mailing History (system shows mail log for
selected member record)
D: Display: Table format

Selected Record (radio button)
Member number
e-mail address
Name of member (segmented, first name, last name)

B: Curser Functions: vertical scroll

The path (element A) is shown and the major functions available from Table 6.1 are active on the user's screen (element B). Element C reveals that the user is presented with special functions to enable the user to select member records (people), enter new member records, find a particular member record or group of member records by inputting a data string in a search field, editing the displayed and selected member record, deleting the selected member record (or records) and showing the mailing history of the selected member record. Element D indicates that the display is in a table format and shows the selected member record with a radio button ON (blank is OFF), the member's record number, the e-mail address of the record and the name of the member. The name of the member is segmented into first name and last name. Element E indicates that the user is provided with cursor functions to vertically scroll and horizontally scroll through the selected member table at element D.

The following Member Search Criteria Table 10.0 explains one methodology of conducting a search through the member records. Other search criteria could be utilized.

Member Search Criteria Table 10.0

Full data base field search
Truncate search term (e.g., search term “Smit!” returns records with Smith, Smithy,
Smitty, Smithe etc.)
Search through e-mail address field and Last Name Member field

The user at SP1 can edit the member records, delete those records, modify those records and see the entire communications history for that member record as indicated above in connection with Table 9.0. Further, the search engine can be customized to search for any field, personal data or demographic data of the members based upon the member data profile. See Table 4.0 above. A fan club ASP operated by a celebrity-sponsor may want to send out a certain e-mail to high income members. Hence, the search engine could have a data input field enabling the user at SP1 to select income level brackets for the members. The income levels selectable by the user at SP1 would match the income levels selectable by the member when the member was initially inputting the data into Member Data Profile Table 4.0. Other search criteria and search engine techniques could be utilized.

The campaign report function 109 (FIG. 5) enables the user at SP1 to generate a large number of reports regarding the scope of an e-mail campaign and the success of an e-mail campaign. The following Campaign Reports Table 11.1 provides an example for a sponsor operating a lottery. Hence, Campaign Reports Table 11.1 is a lottery market report.

Campaign Reports Table 11.1 (e.g., Lottery Market Reports)

Members sort by geographic territory
(state, city, major metropolitan area, zip code)
Member Registration per defined time period
(hourly, daily, weekly, monthly, quarterly)
Member demographics
Point of sale, Point of contact, purchase habits
(keyed to defined fields in Member Profile Data Table)
Member Response characteristics
(frequency of website visits, frequency of purchase,
frequency of coupon redemption (on-line))
E-mail Contact Approved by Member
(e.g., jackpot notifications)
Dollar Volume of Member purchases
(e.g., weekly lottery wager expenditures)

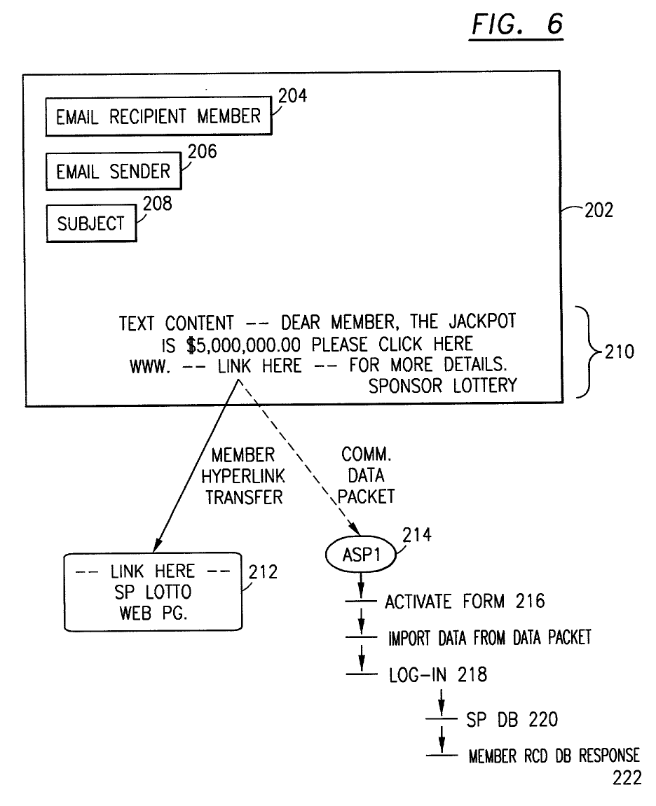

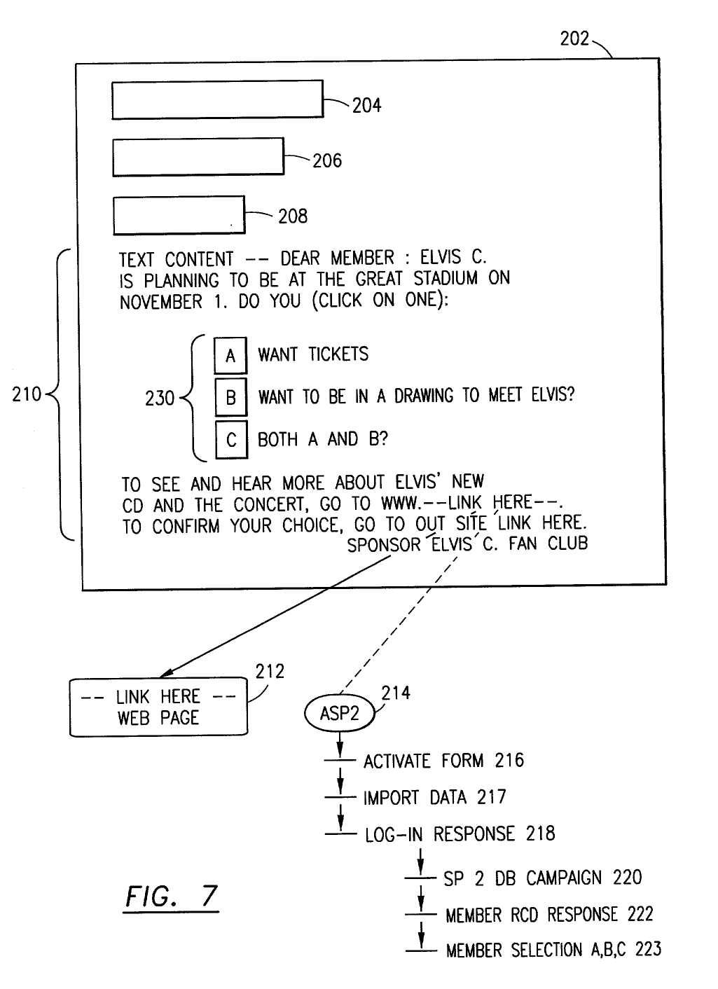

The user at SP1 can sort the member records based upon geographic territory, registrations received by the communication system over a predetermined time period (hourly, daily, weekly, monthly, quarterly or annually or other user selectable time frames) can view the member records based upon member demographics, based upon point of sale, point of contact or purchase habits or member response characteristics. It is well known that individuals who are accustomed to purchasing products and services over the Internet are more susceptible to e-mail campaigns then other individuals who have not purchased goods or services on line or over the Internet. The campaign reports can also be broken down based upon response characteristics of the recipient to earlier e-mail campaigns. The responses are monitored as discussed later in conjunction with FIGS. 6 and 7. In any event, the responses from e-mail campaigns are logged into the member data base records or the campaign data base records. Hence, the campaign report can show frequency of website visits (the member visits to the member web sites are monitored, the frequency of purchases, the frequency of on-line coupon redemptions and other response characteristics can be monitored and reported). Campaign reports also show which members have approved e-mail contacts and of what types of other communications were approved (and in what priority). For example, a lottery sponsor may want an indication of how many members want to be notified when the lottery jackpot exceeds a certain level (e.g., $5,000,000.00). This information can be helpful in determining the effectiveness of other advertising campaigns. The dollar volume of member purchases is also an important indicator.

Graphic Display Report Table 11.2 is a summary of the graphic reports generated by the communication system in order to show the scope of the membership records and the effectiveness of sales. Element A reveals a map of the U.S., color coded to show member distribution in the displayed geographic region. The map includes a color code map key indicating, by bracketed levels, the number of members in each state. Regional maps (element B in Table 11.2) can be provided over the world, country by country, and world regions. State maps, major metropolitan area maps, city maps and street maps may also be utilized.

Graphic Display Report Table 11.2

A: Map of U.S.

color coded to show member distribution
color code map key lists bracket
levels of member counts

B: Regional Maps

world, country by country, world regions
(e.g., Europe, South America)
State maps
U.S. map of major metropolitan areas (MMAs)
city maps
street maps

C: Bar Graphs
D: Frequency of member registrations over predetermined time periods

ordinate (y) number of registrations
abscissa (x) - dates (day week, month) or time (hours)
member count color coded per time
period (red-Monday; blue-Tuesday)

E: Total Members
y: # of members
x: age bracket
color coded key: different colors for different age brackets
Table: list age bracket and % total membership
Table: male %; female %
Table: type of Browser Program as % total members
y: # of members
x: income level (color coded to level)
Table: Income bracket as % total members

The graphic display available in campaign reports function 109 (FIG. 5) as proposed in Table 11.2 includes bar graphs. Element D indicates that bar graphs are available for the frequency of member registration over predetermined time periods wherein the ordinate or y axis indicates the number of registrations and the abscissa (x axis) displays the period oftime (day, week or month or the time in hours or minutes). The member count (new members added to the data base or responsive members responding to an e-mail campaign) for each time period can be color coded for easy review and display. Element E in Table 11.2 shows that bar graph may be provided for the number of members based on age of the member. Responses by age bracket is also a reportable feature. The x and y coordinates are supplied in Table 11.2. Age brackets are color coded for easy identification. A table may accompany the bar graph showing age bracket as a percentage of total membership; the gender as a percentage of membership; type of browser program utilized by the member as a percentage of the total. Responsive communications are also reported in this manner. Additional bar graphs showing income levels and number of members and income bracket as percentage of total members in tabular format may be provided.

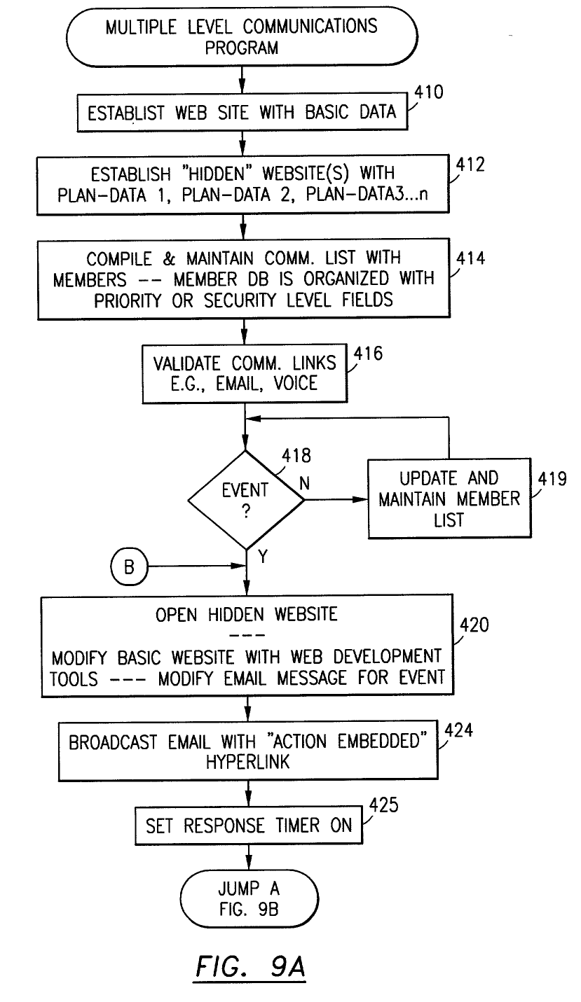

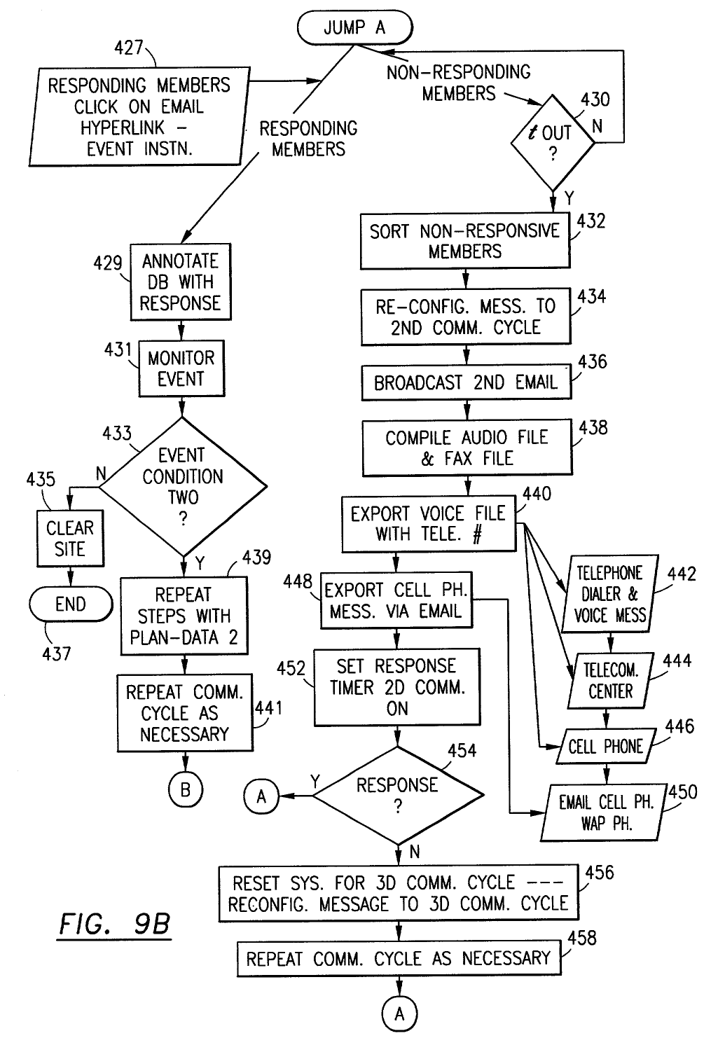

Personal data in the member data record is unique to a particular member. In contrast, demographic information such as income level, types of magazines ordered, commutation to work mileage and other information which identifies a particular member within a population group is generally characterized as demographic data. Some demographic data (income level) is sometimes recognized as personal data. The name and address of a member is personal data. In any event, personal and demographic regarding the member is different than communications data unique to each member. Communications data, as used herein, at least includes an e-mail address for that particular member. Additionally, communications data may include a land-line telephone number, a fax number and a cellular telephone number for that individual. Communications data may also include the pager telephone number if the member carries a pager. The difference between these various communications devices has been diminished over time since cellular telephones are now configured to accept e-mail over the cellular telephone network. Hence, in certain situations, the computer-based communications system with an e-mail facility may be a computer, a hand-held personal data assistant (PDA) or a cellular telephone that has e-mail receipt and sending capacities. Pagers are sometimes configured, via the pager network, to receive e-mail. The same is true regarding a cellular telephone that has Internet communications facilities (typically with e-mail). Since the primary purpose of the present invention involves e-mail communications to members from sponsors, the e-mail facility is of primary importance. The secondary communications channels, that is, audio communications through a land-line telephone system or audio communications through a cellular telephone or pager communications through a paging system represent secondary communications channels in the event the primary e-mail communications channel does not generate a response from the e-mail addressee or member recipient. This is explained later in connection with FIGS. 9A and 9B.

Campaign Details Table 7.4 which follows generally relates to the options routine 112 in FIG. 5.

Campaign Details Table 7.4

A: Path: select options
B: Routine open: mailing options
C: Functions available: all major functions
D: Additional routines available: mailing options - - -
HTML footer - - Text footer - - Export options - - -
vendor specific - - cancel - - OK (accept)
E: Data input fields

default name (e.g., Maryland Lottery)
default e-mail address (sponsorname--at--server12.net)
system selectable configurations

use salutations per default Y/N
show “e-mail sent” count on summary page Y/N
show “e-mail redeem (coupon redemption (on line))” on
summary page Y/N

When the user has selected the options function (element A) and has opened the mailing options function (element B), the user has available all the major functions as identified above in Table 6.1. Additional functions (element D) include (a) mailing options (currently open by the user); (b) HTML footer edit; (c) text footer edit; (d) export data options; (e) vendor specific options; (f) cancel data input; and (g) accept data input. The HTML footer and text footer edit functions enable the user at SP1 to change the footers on all e-mail communications. Export options are generally part of export function 116 in FIG. 5. Of course, the major functions Table 6.1 may be modified to specifically include an “export” function rather than have the export function be subsidiary to options function in the options display characteristic in Table 7.4. Element E in Table 7.4 shows that the user at SP1 is enabled or permitted to input data into certain data fields. Those data fields include an identification of where the e-mail communication is coming from (default name) (addressor) and a default e-mail address. The default e-mail address is typically the name of the sponsor at the central computer 12 server 12 location. The user is permitted to select certain system configurations such as (a) use the salutations in the default (Yes or No); (b) show e-mail sent count on the summary page, and (c) show e-mail redeem or e-mail redemption count on the summary page. This latter feature is the receipt of referral data packet discussed later.

If the user selects the export function (Table 7.4) or function 116 in FIG. 5, the Export Data Table 12.0 provides some exemplary guidelines.

TABLE 12.0
Export Data

| | | |
|---|---|---|
| List all member | Selectable | Fields included |
| Profile Data Fields | Functions | in export file |

The Export Data Table and the Sample Functions Table 12.1 below shows that the user at SP1 can select all the members to be exported to a common delimited file (or any other type of data file) and enables the user to select any one or more of the member data profile characteristics (see Table 4.0) to include those fields in the export or output file or to exclude those fields in the output or exported file. Each major member characteristic in Table 4.0 is listed in the export Data Table 12.0. The export option function enables the user to generate a downloadable file from a member list. This export file could be fed to: a single e-mail address, a telecommunications system which broadcast faxes to members having a fax telephone number, a telephone call list which is fed automatically into a telephone call center 18 (FIG. 1) in order to provide a human voice communications with the member, a telephone call list to generate a pre-recorded voice message to the member, a paging system to page members having pagers, a wide area WAP cellular telephone distribution network, or to a cellular telephone network which accepts e-mail. The data field for the communication may be attached or included with the export data (the selected text or message to be communicated to the member). Selectable functions include add fields, remove fields, add all the fields or remove all the fields. See Table 12.1.

Sample Functions for Export Data Routine 12.1

Add highlighted field to exportable field list
Deleted highlighted field
Add all
Delete all

As explained above, the campaign manager program (ASP) provides a flexible reporting tool for sponsors to produce and monitor the effects of e-mail marketing and communications programs as well as traditional direct mail campaigns. All these campaigns are managed from the same relational data base DB 1. The report manager program enables the sponsor to analyze registered members through graphical comparative reports. A simple query of the member data base allows the sponsor to look at registered customers or members based on gender, age, income and physical location, substantially all in real time. Further, the report manager program can provide analytical reports for each and every profile answer completed by the customers and established in the Member Profile Data Table 4.0. Since that member profile data can be modified initially by the sponsor, the sponsor can easily generate new surveys for consumer or business to business activities, send a test survey to a select number of customers or businesses, report back the results in a short period of time (typical response times are 12 hours), generate a full functional survey and view the responses as they are recovered and logged in by the members solicited by the full survey.

If the user at SP1 selects tools from Primary Function Table 6.1, the web-based communications system at central server 12 provide the following functions in Table 13.0. Other functions may be provided to users.

Functions Available as Tools 13.0

Conduct a random drawing
Create a link for a banner ad
Create a refer-a-friend (recruit new member) campaign
Add a news item for member club
Add a new hyperlink to other web sites
Edit the member club web pages
Web development tool-page editor

The random drawing function 124 in FIG. 5 and in Table 13.0 is discussed later. Refer a friend campaign 126 in FIG. 5 is also discussed later. The user at SP1 is provided with a number of tools to easily edit certain aspects of the sponsor web site or the application service provider web site page 44. These tools include (a) the ability to create a link to add an advertising banner to the sponsor web site; (b) add a new hyperlink to other web sites from the sponsor web site; (c) edit the member club web pages; and (d) other web development tools such as page editor. The creation of a link for a banner add also permits the user at SP1 to follow the hyperlink by the member from the member's pages on the sponsor's web site to the hyperlinked site. A count or tick is entered in the member data base indicating that member has transferred to the hyperlink site. Changing the member club web pages, other simple web development tools and adding new hyperlink to all the web sites is known to person of ordinary skills in the art. These functions are encompassed within web site development tool function 130 in FIG. 5 and hyperlink referrals 132 in FIG. 5.

Campaign Details Table 7.5 outlines the user screens for the random drawing routine.

Campaign Details Table 7.5

A: Path: tools, select random drawing routine
B: Routine open: random drawing
C: Functions Available: all major functions Table 6.1
D: Additional functions or routines available: list - new - review
drawing - review winners - delete
E: Display: headline shows currently selected Drawing Title
(e.g., Tickets to August, 2000 Jazz Festival)
Table display: Title of Drawing, ordered chronologically keyed to
e-mail campaign date
Table fields: operator selects fields to select drawing file or record;

Drawing Title, scope of membership subject to the drawing or descriptor, e-mail campaign data

The path (element A) shows that the user has selected “tools” and currently has opened the “random drawing” function (element B). The functions available (element C) correspond to the major functions identified in Table 6.1 above. Additional functions (element D) include list all winning members for the displayed drawing, add a new drawing, review the drawing parameters and results from the selected drawing, review winners from the selected drawing, and delete the information for the selected drawing. The display (Element E) in Table 7.5 shows the currently selected drawing. The currently selected drawing title is “Tickets to August, 2000 Jazz Festival.” The tabular display lists all drawings, ordered chronologically and keyed to the e-mail campaign date. The table fields displayed in the drawing table include an operator selection field (radio button), Drawing Title, scope of member descriptor and e-mail campaign date. The member descriptor generally describes the range of members targeted for that drawing. For example, all members may be subject to the random drawing or only new registrants or members between user defined dates or time periods may participate in the random drawing. The e-mail campaign date may represent the date and time of the random drawing.

Function Routine Table 14.0 for Random Drawing Features shown below provides some general features and functions available to the user.

Function Routine Table 14.0 for Random Drawing Feature

| | |
|---|---|
| Function | Brief Description of Action and Display |
| List | Shows all Drawing Titles in user selectable format |
| New | Enables user to create new drawing. Typically, user |
| | copies preexisting drawing and modifies features for |
| | new drawing |
| Review drawing | See review drawing table 14.1 |
| Review winners | Displays all winners in flat file (i.e., spreadsheet) |
| | Format fields include: “user select” record field, |
| | member name, member record #, e-mail address, |
| | mailing address, city, state, zip code, phone #, |
| | functions available: replace winner, add winner, delete |
| | winner, list drawings. |
| Delete | This function deletes the drawing record or file from |
| | the sponsor's ASP. |

The Review Drawing Table 14.1 enables the user at SP1 to list the winners of a random drawing.

Review Drawing Table 14.1

A: Path: Tools, select review drawing function
B: Routine open: review drawing
C: Function Available: all major functions Table 6.1
D: Additional functions or routines available: list - new - review
drawing - review winners - delete - cancel
E: Display: Drawing Title (e.g., Tickets to 2000 Jazz Festival)
F: Data input fields

Drawing Title: (defaults to Drawing Title, field editable by user)
registration start date: (pull down menu, year, month, day)
registration end date: see above
geographic territory: (menu or region selectable)
“exclude winner” duration: n days (or months)
number of winners: defaults to n winners from displayed drawing
Minimum age: m age (may be pull down menu)
maximum age: 8 age (see above)
gender: M/F (pull down)

Elements A-D in Table 14.1 are similar to those explained earlier. Element E notes that the user is presented with a display of the current Title of the Drawing. Element F indicates that the user has available to him or her certain data input fields. These data input fields include establishing the current title of the random drawing (typically, the user at SP1 will copy an existing drawing format and re-name the drawing title), identifying the registration start date (that is, the date at which all members subsequent to that start date are available for the drawing), the registration end date (the last date members may join or participate to be eligible for the drawing), the geographic territory which members must live in to be subject to the drawing (menu driven), the “exclude winner” duration (n days, etc.), the number of winners for the proposed drawing, the minimum age, the maximum age and the gender. Certain fields need not be complete to initiate the drawing. The exclude winner function excludes members who have been winners of random drawings within a user selectable time frame (n days, etc.). In other words, if a member has been declared a winner of a drawing within the last calendar quarter her or she may not be eligible for the current drawing. To enable the user to quickly fill out the random drawing function data input, information from the previous drawing is displayed as a default and the user can change that default data as necessary.

Review Drawing Table 14.4 is part of the Format Drawing Characteristic function 134 in FIG. 5. After the user at SP1 has delineated the random drawing, he or she selects the “winners” function. This activates random draw function 136 in FIG. 5. Random draw function 136 in FIG. 5 obtains information from member data base DB1 after a listing of eligible members is defined by the user. This information regarding winners of the random drawing is presented to the user in tabular form. The user in function 138 can check the winners. This display function includes a count of the total winners, and a spreadsheet or flat file listing of the winner's names, member record number, e-mail address, mailing address, city, state, zip code and telephone number. The user has available to him or her the functions “list drawing,” “replace winner,” “add winner,” and “delete winner.” Revise drawing winners function 140 in FIG. 5 recognizes that in certain circumstances, the user may want to delete winners, add more winners or replace winners. This is particularly true if the winners are associated in some manner with the sponsor or with the owners or operators of central server 12. It is fairly well known that employees of the sponsor should not be eligible for prizes given by the sponsor during marketing campaigns. By quickly reviewing either the name of the winners or the e-mail address, the user at SP1 can identify members of the sponsor (or central server organization) or others who are associated with the sponsor. For example, the data base may include sponsor's employees which are listed as members for recording and reporting reasons. If those sponsor members show up as winning members based on a random draw from a selected group of members, this communications system should be able to delete those “unqualified” members. Step 142 in FIG. 5 notifies the winning members via e-mail or otherwise of their prizes. Further, the member data base is annotated to reflect that those members are winning members.

One important feature of the present invention is the utilization in an e-mail communication of a hyperlink and a referral communications data packet. Under the tools function (Table 13.0), is a function “update a referral URL (Universal Resource Locator).” This feature of the present invention generates a response count or tick sent to the referring web site whenever a member clicks on a target hyperlink in a compiled e-mail communication that is part of an e-mail campaign. For example, an e-mail communication sent to the selected members includes an advertisement for a particular vendor, such as The Washington Post. When the member clicks on the hyperlink in the e-mail communication, a tick code including a member ID code, an e-mail campaign ID code, and a sponsor-client code is sent to the referring web site. The member is transferred to the target web site for The Post. In effect, this function establishes a response count to the e-mail campaign. This function is listed under tools function 114 and hyperlink referral 132 in FIG. 5.

FIG. 6 shows e-mail communications 202 having an e-mail recipient or addressee field 204, and e-mail sender or addressor field 206, a subject field 208 and a text 210. The text 210 is compiled in HTML mailing edit function, element D in Campaign Detail Table 7.1. The e-mail text 210 in FIG. 6 may be preexisting, original or a combination. The e-mail includes a hyperlink and an associated referral data packet (associated via a software HTML command with the hyperlink). The hyperlink is identified in FIG. 6 as “link here.” The hyperlink includes a command (a “referral” command) such that when the member clicks on “link here,” the member is transported to a first web site and a message is sent to another web site. In the illustrated embodiment, the members is transported to the “link here” web site which is the sponsor lottery web page 212. In addition, the “link here” command sequence includes a referral communications data packet. That data packet includes at least recipient member data. Preferably, the referral communications packet includes sponsor data, recipient member data (such as e-mail addressee data), e-mail campaign data and, in some situations, member action data. The recipient member data may be (a) the member id or (b) a mail count number. If the mail count number is sent in addition to the e-mail campaign identification, the member data or list of select members for the e-mail campaign will have member-campaign numbers which match the mail count number and the campaign id. The dashed line shown in FIG. 6 illustrates that the communications data packet is sent to ASP1 function 214. ASP1 accepts the referral data packet, extracts the data elements, that is, the sponsor data, recipient member data, e-mail campaign data and, if necessary, member action data. The extraction enables ASP1 in function 214 to determine which data base DB1, DB2, etc., the response is related to. Further, the inclusion in the referral data packet of recipient data enables ASP 1 to annotate or add information to the member data base such that a particular member has responded to the e-mail communication. ASP1 in function 214 activates a form 216, imports the data from the form 216 and from the data packet, logs in the data generally in step 218, logs in the data into the sponsor data base in step 220 and annotates the member record as responding to that e-mail communication in the member data base in step 222. Although in the illustrated embodiment, the referral data packet is sent to the central server 12 and ASP1, that referral data packet may be sent to a trusted third-party (a third web site) and that third web site might generate a report. For example, third web site may be Neilson data reporting web site. The following Referral and Advertising Log Table 5.0 outlines functional steps.

Referral and Advertising Logs (Table 5.0)

| | |
|---|---|
| A1. | Member e-mail includes hyperlink to an advertiser or other |
| | web site |
| A2. | The hyperlink command in e-mail (command “? action =”) |
| | has both (a) the target URL address (Internet address); and, |
| | (b) the referring party (referral source) address (e.g., |
| | ASP-market-provider.provider”.”com and the “action” web page |
| | ASP-market-actions.asp); and, (c) member id, sponsor id, |
| | campaign id and communication id. This “referral code” is unique |
| | to each e-mail. This data is encrypted for privacy. |
| A3. | Member clicks-on advertiser's hyperlink embedded in member |
| | 3-mail, member is hyperlink transported to advertiser and action |
| | code is sent by member's computer to referral source with data |
| | showing (a) who was referred, (b) in response to which e-mail |
| | campaign and (c) sponsor and e-mail count data. |
| A4. | At server 12, the communication is logged in along with date and |
| | time. Results are incorporated into campaign manager data base. |
| B1. | Member clicks-on banner advertisement. |
| B2. | Reference count or tick is stored in sponsor's data base. |
| C1. | Member clicks on banner ad of sponsor displayed on third-party |
| | website. |
| C2. | System logs notes referral. See Member Profile Data Table. |

Elements B1 and B2 in Table 5.0 indicate that a response to an advertisement on a banner ad on the sponsor's web site is annotated in the member data base. Elements C1 and C2 in Table 5.0 indicate that when a member clicks on a banner ad of the sponsor on a third-party web site, the sponsor's data base receives a referral tick without indicating which member “clicked on” the banner add in the third-party web site.

FIG. 6 diagrammatically shows e-mail communication 202 having member selectable fields 230 embedded in the e-mail communications. In developing or creating the e-mail via HTML Text Edit Table 7.1, the user at SP1 can identify member selection as follows: (A) requesting a response from the member that he or she wants tickets, (B) whether he or she wants to participate in a drawing or member selection and (C) member selects both A and B. The member “clicks on” or selects A, B or C. The referral communication data packet includes not only a hyperlink shown in FIG. 7 as “link here” but also member action data responding to the member selection A, B and C in text region 230. Upon selecting A, B or C and upon actuation of “link here,” the member is transported via the hyperlink to link here web page 212. The referral communications data packet is sent, as shown by dashed lines, to another web site ASP2 or third web site 214. Web site 214 activates the form 216, imports data 217, logs in the response 218, places an annotation in the sponsor SP1 data base 1 campaign step 220, annotates the member record in step 222 and further annotates the selection by the member in step 223. An HTML name command could be utilized in the HTML command sequence in member selection area 230 and the “link here” hyperlink which includes a referral communications data packet and member action data. In this manner, not only is the member notified via an e-mail communication but the response by the member is annotated in the sponsor data base. Further, the ability of the member to make one or more selections in the e-mail communication enables the sponsor to conduct surveys on-line quickly.

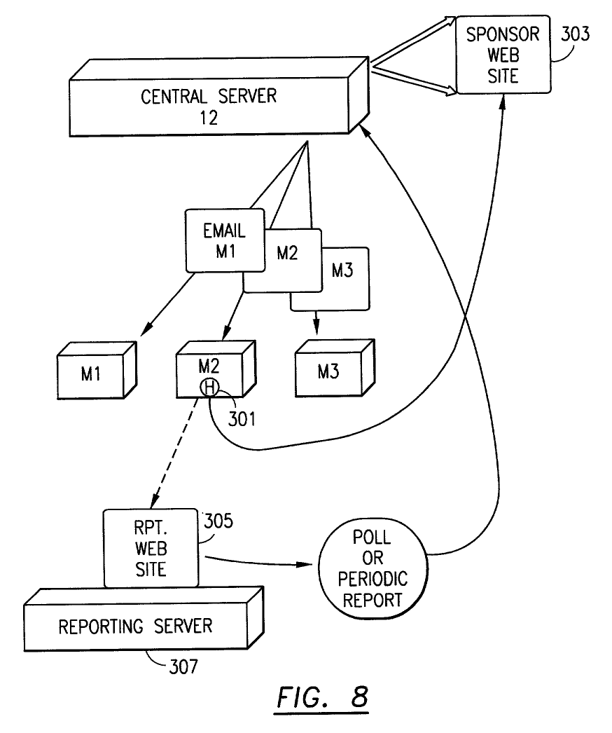

FIG. 8 diagrammatically shows that the e-mail campaign from central server 12 actually is a plurality of e-mails to members M1, M2 and M3. Each of these e-mails is sent to a computer-based communications system owned or operated by member M1, M2 and M3. If one of the members clicks on the hyperlink noted by hyperlink H 301 in FIG. 8, the member is transported to sponsor web site 303. However, a referral communications data packet is sent to a reporting web site 305. The reporting web site may be supported by a neutral or trusted party reporting server 307. Periodically, reporting web site 305 may be polled by central server 12 or the program on site 305 may transmit, on a periodic basis established by the report program at reporting server 307, a certified report indicating member responses. The report program sends the response report to central server 12 and, most likely, to the sponsor's server. In this manner, accurate reporting of member responses can be assured. This reporting is particularly useful if the sponsor is an advertiser and the sponsor wants a high quality guarantee that members have received the communication and have actually accessed the sponsor's web site. The reporting service, such as Neilson tracking service, may be the trusted site.

Under the tools option in the campaign manager, the user at SP 1 may select “refer a friend” routine. Table 15.0 shows the primary elements in that routine.

Refer A Friend Table 15.0

User input fields:

Name of campaign
Description of campaign
Start Date
End date
Title on e-mail message
From name on e-mail message
From e-mail address on e-mail message
Subject on e-mail message

Upon opening “content” routine
Tools Available (standard text edit, plus add image)
Display: see text of e-mail message
Upon opening “HTML Mailing” Routine
Tools available: see above
Display Text in HTML format with embedded hyperlink

The refer a friend campaign essentially provides a coupon to the member if the member is successful in generating or referring a friend to the sponsor. Hence, the user in the refer a friend function as noted in Table 15.0 inputs certain information such as name of the campaign, description of the campaign, the start date of the campaign, the ending date of the campaign, the title on the e-mail message, the from name (addressor) on the e-mail message and the from e-mail address (typically ASP1) on the e-mail address and the subject on the e-mail message. The next screen presented to the user at SP1 enables the user to edit the e-mail content. The tools available for the editing routing are common tools including text edit, character size, bold headings, italics, outline functions, left justify, right justify and insert icons, among others. The user is presented with a display of the e-mail text. Upon opening the HTML mailing edit routine, the user sees the HTML e-mail format with the embedded hyperlink.

In operation, the refer a friend campaign may extend over a one-month period. All the members are sent refer a member or refer a friend e-mail message. In the e-mail message, a hyperlink is included to a new member web site uniquely configured for attracting a referred person. Further, the hyperlink is associated with a referral communication data packet which identifies the sponsor and the initial recipient of the e-mail, that is, the recipient member. The member receiving this refer a friend message, sends the e-mail message (with the embedded hyperlink and referral data) to one or more friends who may be interested in becoming members. If those incipient members click on the hyperlink in the e-mail communication, those incipient members are transferred to the incipient member web site and the referral communications data packet is sent back to the campaign data base. In this manner, the referral data packet not only identifies which member is actively recruiting friends or new members but also identifies the e-mail campaign for refer a friend. The random drawing function can be linked to the refer a friend e-mail campaign such that members, who are successful in having their friends “click on” the embedded hyperlink text and have an indicator in their member records reflecting the receipt of a referral communications data packet, are rewarded by being placed in a limited pool of potential random drawing participants. In this manner, the activity level of the members in this communications system can be increased by offering an economic incentive by way of a random drawing and also increasing the number of members participating in the overall program.

Update News Item Table 16.0

User input fields:

name of e-mail campaign
description of e-mail campaign
start date
end date
title

Upon opening “content” routine
Tools available (standard text editing tools and add image)
Display: see content of web page message

The Update News Item Table 16.0 enables the user at SP1 to identify the e-mail campaign, describe the e-mail campaign, establish start and end dates for that news item and give a title to the news item. The user upon, opening the content function, is shown available tools (such as standard text editing tools and add image tools) and is also displayed the HTML version of the news item. This news item can be sent as an e-mail communication to selected members and can be published on sponsor web site 42.

A variety of web development tools are available to the user at SP1. For example, the sponsor may be permitted to add a hyperlink from the sponsor's web page 42 (see FIG. 5) to a third party such that a member at the sponsor's site 42 can click on that hyperlink and be transported to an advertiser. The sponsor ASP1 and DB1 would be annotated to note the transfer of the member from sponsor site 42 to the hyperlink advertiser. Additional web site development tools include the ability of the user, at SP1 to remove the user message, add a sign-on message for new members, add a welcome message for new members to the web site. These messages are placed on sponsor web site. In the sign-on message function, the user can edit the text with common text editing tools.

The campaign manager program also includes a routine which manages erroneous e-mails or bounce backs. A routine can be established in the campaign program to delete e-mails which were returned by inserting an “out of office reply” in the subject line. In this manner, the “out of office reply” contained in the subject matter line (area 208 and e-mail 208 of FIG. 6) of the bounce back message can be used by typical e-mail programs to sort returning or bounce-back e-mail to server 12. The member data base is configured to ignore and delete these out of office bounce-back replies. However, a count of bounce-backs is provided by the communication system.

Another utilization of the communication system described above is a multilevel and a multi-modal method of communicating. Table 17.0 identifies some examples of this multilevel communications program.

Exemplary Utilization Table 17.0 - Multilevel Comm. Pgm.

Quick response communications system with variable outputs and
adaptive communications modes
Political campaigns
Quick response teams
Disaster preparation and response teams e.g., hurricane, tornado
Emergency medical system response teams, airline crash teams, chemical
or nuclear disaster, riots or civic disturbance teams

FIGS. 9A and 9B diagrammatically show the major functions of this multi-modal method of communicating. In step 410, the sponsor establishes a web site with basic data. In step 412, the sponsor establishes hidden web sites or stored information web sites for various types of responses. As an example, a disaster program for a hurricane is discussed herein. Hence, data plan 1 represents a small category 3 hurricane. Data plan 2 represents a medium size category 4 hurricane. Data plan 3 represents a high risk category 5 hurricane. The response teams and the required information to implement data plans 1, 2 and 3 remains the same for 2-3 years. For example, data plan 1 for a mild hurricane may not include a full scale of evacuation of all coastal regions. In contrast, data plan 3 would include a full evacuation. Hurricane shelters are typically pre-assigned dependent upon the severity of the storm. These plans or security levels for the web sites (a storage of information or data) or priority levels can be established with hidden web sites that are not typically available to the public. The hidden web sites are not linked to public, advertised sites.

In step 414, the sponsor compiles and maintains a communications list with members for the disaster preparation team. These members may be prioritized. One type of priority or security level is shown below in Table 18.

Priority or Security Level Table 18.0

Priority Response Team

members 001-015 (agency decision-makers)

Secondary Response Team

primary service providers
members 016-020 (doctors, firemen, etc.)

Secondary providers

members 021-025 (police, security officers)

Public speakers - communications

members 026-035 (public relations department heads, major news

organizations)

The member data base is organized with a field for priority or security levels. In other words, the agency decision makers would be provided access to all web pages in plan data 1. In contrast, doctors and firemen may be provided access only to a limited number of web sites in the event of a disaster. Step 416 validates the communications links. This validation may include a voice validation utilizing a telephone call center 18 (FIG. 1) or a voice convert function 48 sent over cellular telephone system 18. Responses to the validation call are logged into the data base. Decision step 418 determines whether the event has occurred. If not, the NO branch is taken and the system in step 419 updates and maintains the member list or data base. If the event has occurred, the YES branch is taken and the system in step 420 opens the hidden web sites, modifies the basic web sites with web development tools to input current content or information regarding the disaster and modifies the e-mail message for the particular event. In step 424, the e-mail is broadcast with the action embedded hyperlink. The “member” action embedded hyperlink enables members of the disaster team to select their availability for the event. See FIG. 7. In step 425, a response timer is set ON. The system in jump point A goes to FIG. 9B.

In FIG. 9B, the system splits into a responding members branch and non-responding members branch. Responding members have an input 427. Responding members click on the hyperlink embedded in the e-mail text and are transferred to data plan 1. Also, the referral data packet has annotated the data base indicating the responding team member is “on board.” In step 429, the data base is annotated and indicating that the member has responded to the initial e-mail. Step 431 monitors the event. Step 433 is a decision step inquiring whether the “threat” or event condition has deteriorated or increased to an additional priority or security level. If not, the NO branch is taken and in step 435, the web site is cleared and the system ends in step 437. If the event has not ended or has changed in severity, the YES branch is taken from decision step 433 and, in step 439 the system repeats the earlier step with data plan 2. In step 441, the system repeats the communications cycle as necessary. The system then jumps via jump point B to a point immediately preceding step 420. If data plan 2 is now active, the data plan 2 website is open and an appropriate communication must be sent to the response team.

If the non-responding branch is taken from jump point A in FIG. 9B, decision step 430 determines whether the response timer has timed out. If not, the system loops back awaiting a response or a non-response (the absence of a response) from members which were sent the initial e-mail communications. If the timer times out, the YES branch is taken from decision step 430 and the system executes step 432 which sorts non-responsive members from the data base DB1. In step 434, the system reconfigures the message to provide a second communications cycle. This reconfigured message may also be preexisting message simply copied from the first message. The second e-mail communications message indicates that it is the second communications attempt. In step 436, the second e-mail is broadcast due to the absence of their response to selected members. In step 438, the system compiles an audio file and a fax file for these members. In step 440, the system exports the voice file with the telephone number file to a call center or an audio broadcast unit. This voice file with the telephone number is output to a telephone dialer with a voice message as output 442, telecommunication center with a live operator which calls the designated response team member in step 444, and to the cell phone of the member in step 446. The telephone dialer dials the non-responsive members. When the targeted member answers the phone, the audio message is played (“come on board”). In step 448, an export file is prepared for the cellular telephone of the members when those cellular telephones have an e-mail facility. Output 450 represents the e-mail to cellular telephones which are unable to be reached during the first communications attempt. Step 452 sets another response timer ON for the second communication. Decision step 454 determines whether a response has been obtained. If YES, the system jumps to jump point A which indicates with input 427 that the member is responding by clicking on the hyperlink embedded in the e-mail communication (whether first or second). The response is noted in the member data base by the referral data packet. If the NO branch is taken from decision step 454, the system in step 456 resets the system for a third communication cycle and reconfigures the messages for a third communication cycle. The system in step 458 repeats the communications cycles as necessary until all the members in the disaster team respond appropriately.

It should be noted that although a data base has been described in connection with the present invention a flat file or a spreadsheet may be utilized.

By utilizing a hyperlink embedded in an e-mail communication and a referral communications data packet associated with the hyperlink, a sponsor or other entity can monitor the effect of broadcast e-mail communications. These communications are broadcast to a plurality of members utilizing the e-mail communications with the hyperlink and embedded referral communications data packet.

Further, it should be appreciated that the computer program and communication system described in connection with central server 12 can operate in a very similar manner if utilized on sponsor server 10 (FIG. 1). The computer program can be entirely contained in one central server operable with a plurality of client computers wherein the client computers are operated by members, consumers or business customers. The computer program embodying the functions described herein can be placed in various computer systems to implement the communications system.

The claims appended hereto are meant to cover modifications and changes within the scope and spirit of the present invention.

What is claimed is:

1. An Internet-based method of communicating with a plurality of members, each member having a computer-based communications system with an e-mail facility adapted to be coupled to said Internet, the Internet-based method comprising the steps of:
providing a web-based user interface for data input for said plurality of members, said user interface accepting member data representing characteristics of said members, said member data at least including communications data, which includes a respective e-mail address for each member, and at least one of demographic data and personal data regarding each said member;
organizing said member data into a data structure;
creating an e-mail communication;
embedding in said e-mail communication a hyperlink to a first web site and a referral communications data packet associated with said hyperlink such that, upon actuation of said hyperlink, said referral data packet is adapted to be sent to a second web site, said referral data packet including one or more data elements from the group including sponsor data, recipient member data, e-mail campaign data, and member action data;
preparing a listing of members from said data structure based upon criteria encompassed by said member data;
broadcasting said e-mail communication to members based upon said listing;
reporting the receipt of said referral communications data packet.

2. A method as claimed in claim 1 wherein the step of embedding utilizes a referral data packet having at least two data elements from the group including sponsor data, recipient member data, e-mail campaign data, and member action data.

3. A method as claimed in claim 1 wherein said reporting includes the step of extracting, from said referral data packet, said one or more data elements from the group including sponsor data, recipient member data, e-mail campaign data, and member action data, and wherein the method includes the step of adding said one or more data elements to said data structure in order to determine the response of said members to the broadcast e-mail communication.

4. A method as claimed in claim 3 wherein the reporting step occurs either at said second web site or at a third web site, and the method includes accepting, from said third web site, the reporting of said receipt of said referral communications data packet.

5. A method as claimed in claim 1 wherein the step of providing a user interface includes enabling input by each respective member to classify himself or herself with demographic data thereby associating said member with one or more groups of members, and enabling input by each respective member to input personal data distinguishing said member from said plurality of members.

6. A method as claimed in claim 1 including the step of maintaining a copy of all e-mail communications sent to each member and including the step of enabling output of all said e-mail communications to each respective member to view his or her own e-mail communications.

7. A method as claimed in claim 2 wherein the step of embedding utilizes a referral communications data packet having the following data elements: sponsor data, recipient member data, and e-mail campaign data.

8. A method as claimed in claim 1 wherein the step of creating said e-mail communications includes the step of creating a member selectable list of choices and includes the step of associating the selected choice in said member action data.

9. A method as claimed in claim 1 including the step of permitting each respective member to edit his or her own member data via said user interface.

10. A method as claimed in claim 1 including the step of confirming said e-mail address for respective members by (a) sending a test e-mail addressed to said respective member and (b) confirming said e-mail address based upon an absence of a response from the e-mail addressee.

11. A method as claimed in claim 1 including the steps of sorting through said member data and selecting a sub-plurality based upon further criteria encompassed by said member data, and randomly selecting one or more members from said sub-plurality as winning members, notifying said winning members via a winner notification e-mail communication and publicly posting information relative to said winning member or members on said Internet.

12. A method as claimed in claim 11 including recording winning member data as apart of said member data and including the step of excluding winning members from said random selection step for a pre-programmed period of time after winner notification.

13. A method as claimed in claim 1 wherein the step of creating an e-mail communication includes incorporating preexisting material into said e-mail communication.

14. A method as claimed in claim 1 wherein the step of embedding utilizes a referral communications data packet having the following data elements: sponsor data, recipient member data, and e-mail campaign data.

15. A method as claimed in claim 14 wherein said reporting includes the step of extracting, from said referral data packet, said data elements and wherein the method includes the step of adding said data elements to said data structure in order to determine the response of said members to the broadcast e-mail communication.

16. A method as claimed in claim 15 wherein the reporting step occurs either at said second web site or at a third web site, and the method includes accepting, from said third web site, the reporting of said receipt of said referral communications data packet.

17. A method as claimed in claim 16 wherein the step of providing a user interface includes enabling input by each respective member to classify himself or herself with demographic data thereby associating said member with one or more groups of members, and enabling input by each respective member to input personal data distinguishing said member from said plurality of members.

18. A method as claimed in claim 17 wherein the step of creating said e-mail communications includes the step of creating a member selectable list of choices and includes the step of associating the selected choice in said member action data.

19. A method as claimed in claim 18 including the step of permitting each respective member to edit his or her own member data via said user interface.

20. A method as claimed in claim 19 including the step of confirming said e-mail address for respective members by (a) sending a test e-mail addressed to said respective member and (b) confirming said e-mail address based upon an absence of a response from the e-mail addressee.

21. A method as claimed in claim 20 wherein the step of creating an e-mail communication includes incorporating preexisting material into said e-mail communication.

22. A method as claimed in claim 21 including the steps of sorting through said member data and selecting a sub-plurality based upon further criteria encompassed by said member data, and randomly selecting one or more members from said sub-plurality as winning members, notifying said winning members via a winner notification e-mail communication and publicly posting information relative to said winning member or members on said Internet.

23. A method as claimed in claim 22 including recording winning member data as apart of said member data and including the step of excluding winning members from said random selection step for a pre-programmed period of time after winner notification.

24. A multi-modal method of communicating of communicating with a plurality of members, each member having at least one computer-based communications system with an e-mail facility adapted to be coupled to the Internet, and some members having respective pagers, cellular telephones and land-line telephones coupled via telecommunications networks to said Internet, the multi-modal method of communicating comprising the steps of:
providing an interface for data input relating to said plurality of members, said interface accepting member data representing characteristics of said members, said member data at least including communications data, which includes a respective e-mail address for each member and, for said some members, includes a respective pager, cellular telephone number and land-line telephone number, if available for said some members;
organizing said member data into a data structure;
creating an e-mail communication;
embedding in said e-mail communication a hyperlink to a first web site and a referral communications data packet associated with said hyperlink such that, upon actuation of said hyperlink, said referral data packet is adapted to be sent to a second web site, said referral data packet including at least recipient member data and e-mail campaign data;
broadcasting said e-mail communication to said plurality of members;
reporting the receipt of said referral communications data packet and logging the same into said data structure;
in the event that some members are non-responsive to said e-mail communications noted by an absence of receipt data in said data structure,
creating a digital version of an audio communication, said audio communication adapted to be presented over said cellular telephones and land-line telephones to non-responsive members who have respective cellular telephones or land-line telephones;
for said some members who are non-responsive and have respective pagers, creating a paging message representing a request for a response, said paging message adapted to be presented via said respective pagers;
broadcasting said digital version of said audio message and said paging message via said Internet and said telecommunications networks to said non-responsive members;
providing a further interface for responsive data input from said non-responsive members; and,
logging response data into said data structure.

25. A method as claimed in claim 24 including providing a plurality of web sites, each web site characterized as having a different priority, said members classified according to priority levels, each member priority level associated with a corresponding web site priority, said member data including member priority level data; with respect to the step of embedding, said first web site is defined as the plurality of prioritized web sites, the step of embedding including the step of placing prioritized web site hyperlinks into each e-mail communication corresponding to the member priority level data.

26. A method as claimed in claim 24 wherein said member data includes personal data regarding each member and wherein the step of providing an interface for data input includes the step of permitting each respective member to edit his or her own member data.

27. A method as claimed in claim 25 including the step of preparing a listing of members from said data structure based upon criteria encompassed by said member data and the step of broadcasting includes the step of broadcasting based upon said listing.

28. A method as claimed in claim 24 wherein the step of providing an interface for data input includes a web-based interface for data input relating to said plurality of members.

29. A method as claimed in claim 25 wherein said different priority web sites represent different levels of information for an emergency response team, said plurality of members being part of said emergency response team, said step of creating an e-mail communication includes the step of inputting current data representing an emergency and said step of broadcasting representing a step of mobilizing said emergency response team.

30. A method as claimed in claim 25 wherein said referral communications data packet includes member action data as a data element, and said step of creating said e-mail communications includes the step of creating a member selectable list of choices in said e-mail communication and includes the step of associating the selected choice in said member action data.

31. A method as claimed in claim 24 wherein said reporting includes the step of extracting, from said referral data packet, said recipient member data and e-mail campaign data, and wherein the method includes the step of adding said data elements to said data structure in order to determine the response of said members to the broadcast e-mail communication.

32. A method as claimed in claim 31 wherein the reporting step occurs either at said second web site or at a third web site, and the method includes accepting, from said third web site, the reporting of said receipt of said referral communications data packet.

33. A method as claimed in claim 24 including the step of maintaining a copy of all e-mail communications sent to each member and including the step of enabling output of all said e-mail communications to each respective member to view his or her own e-mail communications.

34. A method as claimed in claim 25 wherein said member data includes personal data regarding each member and wherein the step of providing an interface for data input includes the step of permitting each respective member to edit his or her own member data.

35. A method as claimed in claim 34 including the step of preparing a listing of members from said data structure based upon criteria encompassed by said member data and the step of broadcasting includes the step of broadcasting based upon said listing.

36. A method as claimed in claim 35 wherein the step of providing an interface for data input includes a web-based interface for data input relating to said plurality of members.

37. A method as claimed in claim 36 wherein said referral communications data packet includes member action data as a data element, and said step of creating said e-mail communications includes the step of creating a member selectable list of choices in said e-mail communication and includes the step of associating the selected choice in said member action data.

38. A method as claimed in claim 37 wherein said reporting includes the step of extracting, from said referral data packet, said recipient member data and e-mail campaign data, and wherein the method includes the step of adding said data elements to said data structure in order to determine the response of said members to the broadcast e-mail communication.

39. A method as claimed in claim 38 wherein said different priority web sites represent different levels of information for an emergency response team, said plurality of members being part of said emergency response team, said step of creating an e-mail communication includes the step of inputting current data representing an emergency and said step of broadcasting representing a step of mobilizing said emergency response team.

40. A method of monitoring the effect of broadcast e-mail communications over the Internet to a plurality of members, each member having a computer-based communications system with an e-mail facility and an associated e-mail address adapted to be coupled to said Internet, the method comprising the steps of:
creating an e-mail communication;
embedding in said e-mail communication a hyperlink to a first web site and a referral communications data packet associated with said hyperlink such that, upon actuation of said hyperlink, said referral data packet is adapted to be sent to a second web site, said referral data packet including one or more data elements from the group including sponsor data, recipient member data, e-mail campaign data, and member action data;
sending said e-mail communication to one or more select members.

41. A computer-readable storage medium containing computer executable code for instructing a computer to establish an Internet-based method of communicating with a plurality of members, each member having a computer-based communications system with an e-mail facility adapted to be coupled to said Internet, the code instructing the computer to operate as follows:
providing a user interface for data input for said plurality of members, said user interface accepting member data representing characteristics of said members, said member data at least including communications data, which includes a respective e-mail address for each member;
organizing said member data into a data structure;
creating an e-mail communication;
embedding in said e-mail communication a hyperlink to a first web site and a referral communications data packet associated with said hyperlink such that, upon actuation of said hyperlink, said referral data packet is adapted to be sent to a second web site, said referral data packet including one or more data elements from the group including sponsor data, addressor data, addressee data, and e-mail campaign data;
preparing a listing of members from said data structure;
broadcasting said e-mail communication to members based upon said listing;
reporting the receipt of said referral communications data packet.

42. A computer-readable storage medium containing computer executable code for instructing a computer to establish an Internet-based method of communicating with a plurality of members, each member having a computer-based communications system with an e-mail facility adapted to be coupled to said Internet, the code instructing the computer to operate as follows:
providing a user interface for data input for said plurality of members, said user interface accepting member data representing characteristics of said members, said member data at least including communications data, which includes a respective e-mail address for each member, and at least one of demographic data and personal data regarding each said member;
organizing said member data into a data structure;
creating an e-mail communication;
embedding in said e-mail communication a hyperlink to a first web site and a referral communications data packet associated with said hyperlink such that, upon actuation of said hyperlink, said referral data packet is adapted to be sent to a second web site, said referral data packet including one or more data elements from the group including sponsor data, recipient member data, e-mail campaign data, and member action data;
preparing a listing of members from said data structure based upon criteria encompassed by said member data;
broadcasting said e-mail communication to members based upon said listing;
reporting the receipt of said referral communications data packet.

43. A computer-readable storage medium containing computer executable code as claimed in claim 42 for instructing a computer to operate by wherein the operation of embedding utilizes a referral communications data packet having the following data elements: sponsor data, recipient member data, and e-mail campaign data.

44. A computer-readable storage medium containing computer executable code as claimed in claim 43 for instructing a computer to operate wherein the reporting includes extracting, from said referral data packet, said data elements and wherein the operation includes adding said data elements to said data structure in order to determine the response of said members to the broadcast e-mail communication.

45. A computer-readable storage medium containing computer executable code as claimed in claim 44 for instructing a computer to operate wherein the reporting occurs either at said second web site or at a third web site, and operation accepts, from said third web site, the reporting of said receipt of said referral communications data packet.

46. A computer-readable storage medium containing computer executable code as claimed in claim 45 for instructing a computer to operate wherein the user interface includes enables input by each respective member to classify himself or herself with demographic data thereby associating said member with one or more groups of members, and enables input by each respective member to input personal data distinguishing said member from said plurality of members.

47. A computer-readable storage medium containing computer executable code as claimed in claim 46 for instructing a computer to operate wherein the creation of said e-mail communications includes creating a member selectable list of choices and includes associating the selected choice in said member action data.

48. A computer-readable storage medium containing computer executable code as claimed in claim 47 for instructing a computer to operate including permitting each respective member to edit his or her own member data via said user interface.

49. A computer-readable storage medium containing computer executable code as claimed in claim 48 for instructing a computer to operate including confirming said e-mail address for respective members by (a) sending a test e-mail addressed to said respective member and (b) confirming said e-mail address based upon an absence of a response from the e-mail addressee.

50. A computer-readable storage medium containing computer executable code as claimed in claim 49 for instructing a computer to operate wherein the creation of said e-mail communication includes incorporating preexisting material into said e-mail communication.

51. A computer-readable storage medium containing computer executable code as claimed in claim 50 for instructing a computer to operate including sorting through said member data and selecting a sub-plurality based upon further criteria encompassed by said member data, and randomly selecting one or more members from said sub-plurality as winning members, notifying said winning members via a winner notification e-mail communication and publicly posting information relative to said winning member or members on said Internet.

52. A computer-readable storage medium containing computer executable code as claimed in claim 51 for instructing a computer to operate including recording winning member data as apart of said member data and including excluding winning members from said random selection step for a pre-programmed period of time after winner notification.

52. A computer-readable storage medium containing computer executable code for instructing a computer to establish a multi-modal method of communicating of communicating with a plurality of members, each member having at least one computer-based communications system with an e-mail facility adapted to be coupled to the Internet, and some members having respective pagers, cellular telephones and land-line telephones coupled via telecommunications networks to said Internet, the code instructing the computer to operate as follows:
providing an interface for data input relating to said plurality of members, said interface accepting member data representing characteristics of said members, said member data at least including communications data, which includes a respective e-mail address for each member and, for said some members, includes a respective pager, cellular telephone number and land-line telephone number, if available for said some members;
organizing said member data into a data structure;
creating an e-mail communication;
embedding in said e-mail communication a hyperlink to a first web site and a referral communications data packet associated with said hyperlink such that, upon actuation of said hyperlink, said referral data packet is adapted to be sent to a second web site, said referral data packet including at least recipient member data and e-mail campaign data;
broadcasting said e-mail communication to said plurality of members;
reporting the receipt of said referral communications data packet and logging the same into said data structure;
in the event that some members are non-responsive to said e-mail communications noted by an absence of receipt data in said data structure,
creating a digital version of an audio communication, said audio communication adapted to be presented over said cellular telephones and land-line telephones to non-responsive members who have respective a cellular telephone or land-line telephone;
for said some members who are non-responsive and have respective pagers, creating a paging message representing a request for a response, said paging message adapted to be presented via said respective pager to non-responsive members who have respective pagers;
broadcasting said digital version of said audio message and said paging message via said Internet and said telecommunications networks to said non-responsive members;
providing a further interface for responsive data input from said non-responsive members; and,
logging response data into said data structure.

53. A computer-readable storage medium containing computer executable code as claimed in claim 52 for instructing a computer to operate including providing a plurality of web sites, each web site characterized as having a different priority, said members classified according to priority levels, each member priority level associated with a corresponding web site priority, said member data including member priority level data; with respect to the step of embedding, said first web site is defined as the plurality of prioritized web sites, the operation of embedding including placing prioritized web site hyperlinks into each e-mail communication corresponding to the member priority level data.

54. A computer-readable storage medium containing computer executable code as claimed in claim 53 for instructing a computer to operate wherein said member data includes personal data regarding each member and wherein the operation of providing an interface for data input includes permitting each respective member to edit his or her own member data.

55. A computer-readable storage medium containing computer executable code as claimed in claim 54 for instructing a computer to operate including preparing a listing of members from said data structure based upon criteria encompassed by said member data and broadcasting based upon said listing.

56. A computer-readable storage medium containing computer executable code as claimed in claim 55 for instructing a computer to operate wherein providing an interface for data input includes providing a web-based interface for data input relating to said plurality of members.

57. A computer-readable storage medium containing computer executable code as claimed in claim 56 for instructing a computer to operate wherein said referral communications data packet includes member action data as a data element, and wherein the creation of said e-mail communications includes creating a member selectable list of choices in said e-mail communication and includes associating the selected choice in said member action data.

58. A computer-readable storage medium containing computer executable code as claimed in claim 57 for instructing a computer to operate wherein said reporting includes extracting, from said referral data packet, said recipient member data and e-mail campaign data, and wherein the operation includes adding said data elements to said data structure in order to determine the response of said members to the broadcast e-mail communication.

59. A computer-readable storage medium containing computer executable code as claimed in claim 58 for instructing a computer to operate wherein said different priority web sites represent different levels of information for an emergency response team, said plurality of members being part of said emergency response team, said step of creating an e-mail communication includes the step of inputting current data representing an emergency and said step of broadcasting representing a step of mobilizing said emergency response team.
